(19) United States
(12) Patent Application Publication
(10) Pub. No.: US 2017/0066485 A1
(43) Pub. Date: Mar. 9, 2017

(54) VEHICLE BODY FRAMEWORK STRUCTURE

(71) Applicant: HONDA MOTOR CO., LTD., MINATO-KU, TOKYO (JP)

(72) Inventors: Hiroshi YAMAGUCHI, WAKO-SHI (JP); Ken YASUI, WAKO-SHI (JP); Masaaki YAMANE, WAKO-SHI (JP); Shutaro SAO, WAKO-SHI (JP)

(21) Appl. No.: 15/122,775

(22) PCT Filed: Mar. 11, 2015
(86) PCT No.: PCT/JP2015/057111

§ 371 Date: Aug. 31, 2016

(30) Foreign Application Priority Data
Mar. 14, 2014 (JP) 2014-051995

(51) Int. Cl. B62D 27/02; B62D 29/00; B62D 25/08; B62D 25/02; B62D 25/20; B62D 21/10; B62D 65/02

(52) U.S. Cl. CPC B62D 27/026; B62D 21/10; B62D 29/002; B62D 65/02; B62D 27/023; B62D 25/025; B62D 25/2036; B62D 25/087; B60Y 2410/124; B60Y 2304/07

(57) ABSTRACT

In a vehicle body framework structure, a closed cross-section frame portion is formed by welding a first outer panel and a second outer panel, and an inner panel is arranged in a closed cross section of the closed cross-section frame portion. An upper joint piece of the inner panel is joined to a first wall portion of the first outer panel by spot welding, and a foaming adhesive material is temporarily fixed to a second wall portion of the second outer panel. When the foaming adhesive material is foamed, a foaming adhesive portion of the foamed foaming adhesive material adheres a lower joint piece of the inner panel and the second wall portion of the second outer panel.

### TECHNICAL FIELD

The present invention relates to a vehicle body framework structure in which a closed cross-section frame portion is formed by a plurality of outer panels, and an inner panel is installed in a closed cross section of the closed cross-section frame portion.

### BACKGROUND ART

There is a vehicle body framework structure which secures its rigidity and strength by forming a closed cross-section frame portion by joining a plurality of outer panels by spot welding, and installing an inner panel in a closed cross section formed by the closed cross-section frame portion.

To secure the rigidity and strength of the vehicle body framework structure, a plurality of portions of the inner panel are preferably joined to the closed cross-section frame portion. However, the inner panel is installed in the closed cross section of the closed cross-section frame portion.

Accordingly, to join the inner panel to the closed cross-section frame portion by spot welding, it is necessary to form an insertion hole in the closed cross-section frame portion, and insert a spot gun for spot welding into the closed cross section through the insertion hole. Since the insertion hole is formed in the closed cross-section frame portion, it is difficult to secure the rigidity and strength of the vehicle body framework structure. Also, if the closed cross-section frame portion has a small closed cross section, it may be impossible to form a spot-gun insertion hole in the closed cross-section frame portion.

As a joining means other than spot welding, MIG welding and a joining method using a bolt and nut are known. In MIG welding, the inner panel can be joined to the closed cross-section frame portion from outside the closed cross-section frame portion by using a welding wire. Furthermore, when using a bolt and nut, the inner panel can be joined to each panel by the bolt by welding the nut to the inner panel or closed cross-section frame portion in advance.

In MIG welding, however, it may be difficult to move the welding wire to a predetermined welding portion depending on the application of the vehicle body framework structure. In addition, the method using a bolt and nut requires an assembly tolerance (accuracy) of the inner panel and closed cross-section frame portion, so the workability may decrease.

A high-rigidity foam body (to be referred to as a foaming adhesive material hereinafter) is known as a material for adhering metals such as the inner panel and closed cross-section frame portion. The foaming adhesive material mainly contains a metal-adhesive resin, and, when foaming by heating, increases the rigidity, and adheres to a metal surface (see, for example, PTL 1).

It may be possible to adhere the inner panel to the closed cross-section frame portion by using this foaming adhesive material.

To adhere the inner panel to the closed cross-section frame portion by using the conventional foaming adhesive material, the foaming adhesive material must be arranged between the inner panel and closed cross-section frame portion. In the vehicle body framework structure, however, the inner panel is installed in the closed cross section formed by the closed cross-section frame portion.

Accordingly, it is difficult to arrange the foaming adhesive material between the inner panel and closed cross-section frame portion when assembling the vehicle body framework structure, so demands have arisen for a practical technique of arranging the foaming adhesive material.

### CITATION LIST

### Patent Literature

PTL 1: Japanese Patent Laid-Open No. 9-176358

### SUMMARY OF INVENTION

### Technical Problem

It is an object of the present invention to provide a vehicle body framework structure in which an inner panel installed in a closed cross section can be joined to a closed cross-section frame portion by a foaming adhesive material.

### Solution to Problem

An invention according to claim 1 provides a vehicle body framework structure in which a closed cross-section frame portion having a closed cross section is formed by welding a plurality of outer panels, and an inner panel arranged in the closed cross section is formed in the closed cross-section frame portion, wherein a gap is set between the inner panel and the closed cross-section frame portion, and a foaming adhesive material configured to adhere the inner panel and the closed cross-section frame portion is arranged in the gap.

When assembling the plurality of outer panels and the inner panel, the inner panel is welded to an outer panel selected from the plurality of outer panels before the closed cross-section frame portion is formed by welding the plurality of outer panels. After the inner panel is welded to the selected outer panel, the closed cross-section frame portion is formed by welding the remaining outer panel to the selected out panel.

Accordingly, when welding the remaining outer panel to the selected outer panel, the inner panel may interfere with the remaining outer panel. To avoid this interference of the inner panel with the remaining outer panel, therefore, the gap is secured between the remaining outer panel and the inner panel.

In claim 1, therefore, the gap is set between the remaining outer panel (that is, the closed cross-section frame portion) and the inner panel, and the foaming adhesive material is arranged in the gap.

Preferably, in an invention according to claim 2, the foaming adhesive material includes a temporary fixing portion to be temporarily fixed to one of the closed cross-section frame portion and the inner panel, and a foaming adhesive portion formed in the temporary fixing portion, and configured to adhere the inner panel and the closed cross-section frame portion.

Preferably, an invention according to claim 3 includes a guide hole in a portion, which faces the foaming adhesive portion, of the other of the closed cross-section frame portion and the inner panel.

Preferably, in an invention according to claim 4, the temporary fixing portion and the foaming adhesive portion of the foaming adhesive material are integrated by a foaming adhesive capable of adhering the inner panel and the closed cross-section frame portion.

Preferably, in an invention according to claim 5, the foaming adhesive is a molded composition which mainly contains a metal-adhesive resin, and, when foaming by heating, adheres to the inner panel and the closed cross-section frame portion, and increases rigidity.

Preferably, an invention according to claim 6 includes a through hole which is formed in one of the closed cross-section frame portion and the inner panel, and into which the temporary fixing portion is inserted, wherein the temporary fixing portion includes an insertion portion configured to reduce a diameter toward a distal end portion such that the insertion portion can be inserted into the through hole, and a fitting portion formed in a proximal portion of the insertion portion, and formed into a recessed shape such that the fitting portion can be fitted in the through hole, and the temporary fixing portion is temporarily fixed to one of the closed cross-section frame portion and the inner panel by fitting the fitting portion in the through hole.

Preferably, in an invention according to claim 7, the temporary fixing portion includes at least one groove open in a distal end portion of the insertion portion, and extending toward the proximal portion of the insertion portion.

Preferably, in an invention according to claim 8, the temporary fixing portion includes at least one slit extending in an axial direction of the foaming adhesive material, and open in a direction perpendicular to the axial direction of the foaming adhesive material.

Preferably, in an invention according to claim 9, the slit is extended to the foaming adhesive portion such that a surface of the foaming adhesive material, which opposes the other of the closed cross-section frame portion and the inner panel, opens.

Preferably, in an invention according to claim 10, one of the closed cross-section frame portion and the inner panel includes a locking piece configured to deform while abutting against the temporary fixing portion to be inserted into the through hole.

Preferably, in an invention according to claim 11, the temporary fixing portion and the foaming adhesive portion of the foaming adhesive material are formed into a substantially U shape when viewed sideways such that one of the closed cross-section frame portion and the inner panel is sandwiched, the foaming adhesive material includes a pawl formed on one of the temporary fixing portion and the foaming adhesive portion, and a pawl engages with an engaging hole formed in one of the closed cross-section frame portion and the inner panel, in a state in which the foaming adhesive material sandwiches one of the closed cross-section frame portion and the inner panel.

Preferably, in an invention according to claim 12, the inner panel includes a shielding wall perpendicular to a longitudinal direction of the closed cross-section frame portion, and having an outer edge formed along an inner surface of the closed cross-section frame portion, and a joint piece projecting along the inner surface of the closed cross-section frame portion from the outer edge of the shielding wall, and a recess is formed in one of the joint piece and the closed cross-section frame portion such that the recess is recessed away from the other, in order to form the gap between the joint piece and the closed cross-section frame portion.

Preferably, in an invention according to claim 13, the plurality of outer panels include a first outer panel and at least two second outer panels, the closed cross-section frame portion as a vehicle body framework is formed by assembling the at least two second outer panels to the first outer panel, the at least two second outer panels are divided in the longitudinal direction of the closed cross-section frame portion, thereby forming a dividing portion in each second outer panel, overlapping portions where the dividing portions are overlapped are formed, the gap is set between the overlapping portions, and the foaming adhesive material for adhering the overlapping portions is placed in the gap.

### Advantageous Effects of Invention

In the invention according to claim 1, the gap is set between the closed cross-section frame portion and inner panel, and the foaming adhesive material is placed in the gap. In a state in which the closed cross-section frame portion is formed, therefore, the foaming adhesive material can be adhered to the inner panel and closed cross-section frame portion by being foamed by heating.

This makes it possible to join the inner panel and closed cross-section frame portion by the foaming adhesive material.

In this invention, the portion where the gap is set between the inner panel and closed cross-section frame portion is difficult to join by MIG welding or a bolt and nut, so joint portions to be formed by MIG welding or a bolt and nut are limited. By contrast, it is possible, by foaming the foaming adhesive material, to fill the gap set between the inner panel and closed cross-section frame portion with the foaming adhesive material, thereby adhering the inner panel and closed cross-section frame portion. Consequently, the rigidity and strength of the vehicle body framework structure can suitably be secured.

In the invention according to claim 2, the foaming adhesive material includes the temporary fixing portion and foaming adhesive portion. When assembling the vehicle body framework structure, therefore, the temporary fixing portion can temporarily be fixed to one of the closed cross-section frame portion and inner panel in advance.

Accordingly, the foaming adhesive portion of the foaming adhesive material can easily be arranged in the gap set between the inner panel and closed cross-section frame portion.

The invention according to claim 3 includes the guide hole in the portion, which faces the foaming adhesive portion, of the other of the closed cross-section frame portion and inner panel. When the foaming adhesive portion foams, therefore, the formed foaming adhesive portion can be introduced into the guide hole.

Consequently, the portion facing the foaming adhesive portion can be adhered more strongly by the foamed foaming adhesive portion, so the joint strength between the closed cross-section frame portion and inner panel can further be increased.

In the invention according to claim 4, the temporary fixing portion is formed by using a foaming adhesive. This temporary fixing portion is temporarily fixed to one of the closed cross-section frame portion and inner panel by being inserted into the through hole formed in the one of the closed cross-section frame portion and inner panel. The temporary fixing portion temporarily fixed to the one of the closed cross-section frame portion and inner panel is inserted into the through hole and projected to the side opposite to the insertion side.

Accordingly, the temporary fixing portion can be foamed on the side opposite to the insertion side. This makes it possible to strongly adhere the side opposite to the insertion side by the foamed temporary fixing portion, and further increase the joint strength between the closed cross-section frame portion and inner panel.

In the invention according to claim 5, the molded composition of the foaming adhesive is set to increase the rigidity when foamed. By adhering this foaming adhesive (that is, the foaming adhesive portion) to the closed cross-section frame portion and inner panel, the closed cross-section frame portion and inner panel are joined by the high-rigidity foaming adhesive.

Accordingly, a load can suitably be transmitted between the closed cross-section frame portion and inner panel. This makes it possible to prevent deformation of the closed cross section of the closed cross-section frame portion by the inner panel, and increase the rigidity and strength of the closed cross-section frame portion by the inner panel.

In the invention according to claim 6, the insertion portion of the temporary fixing portion can be inserted into the through hole by reducing the diameter of the insertion portion toward the distal end portion. Therefore, the insertion portion can easily be inserted into the through hole without any trouble.

As a consequence, it is possible to increase the workability of the work of temporarily fixing the temporary fixing portion (that is, the foaming adhesive material) to one of the closed cross-section frame portion and inner panel.

In the invention according to claim 7, at least one groove is formed in the temporary fixing portion, and opened in the distal end portion of the insertion portion. When inserting the temporary fixing portion into the through hole, therefore, the insertion portion can elastically be deformed toward the groove by causing the insertion portion to interfere with the edge of the through hole.

This makes it possible to reduce the diameter of the insertion portion in accordance with the through hole, and more easily insert the temporary fixing portion into the through hole.

In the invention according to claim 8, at least one slit is formed in the temporary fixing portion. When inserting the temporary fixing portion into the through hole, therefore, the insertion portion can elastically be deformed toward the slit by causing the insertion portion to interfere with the edge of the through hole.

This makes it possible to reduce the diameter of the insertion portion in accordance with the through hole, and more easily insert the temporary fixing portion into the through hole.

In the invention according to claim 9, the foaming adhesive portion is opened by extending the slit to the foaming adhesive portion. When inserting the temporary fixing portion into the through hole, therefore, the fitting portion and foaming adhesive portion can be moved toward the slit together with the insertion portion.

This makes it possible to reduce the diameter of the fitting portion in accordance with the through hole. Accordingly, the insertion portion can be inserted into the through hole more easily even when the diameter of the through hole is decreased. The rigidity and strength of one of the closed cross-section frame portion and inner panel can be increased by decreasing the diameter of the through hole. Furthermore, the machining tolerance of the through hole can be absorbed by reducing the diameter of the fitting portion in accordance with the through hole. This can further facilitate the work of inserting the temporary fixing portion into the through hole.

In the invention according to claim 10, one of the closed cross-section frame portion and inner panel has the locking piece, and the locking piece can deform when abutting against the temporary fixing portion. When inserting the temporary fixing portion into the through hole, therefore, the temporary fixing portion can easily be inserted into the through hole by deforming the locking piece by the temporary fixing portion.

In addition, the locking piece can be abutted against the temporary fixing portion inserted into the through hole. This makes it possible to prevent removal of the temporary fixing portion from the through hole by the locking piece, and reliably temporarily fix the temporary fixing portion in the through hole.

In the invention according to claim 11, the foaming adhesive material is formed into an almost U shape when viewed sideways by the temporary fixing portion and foaming adhesive portion, and the pawl is formed on one of the temporary fixing portion and foaming adhesive portion. Therefore, the pawl can be engaged with the engaging hole by sliding one of the closed cross-section frame portion and inner panel so as to be sandwiched by the foaming adhesive material.

Accordingly, it is possible to easily attach the foaming adhesive material to one of the closed cross-section frame portion and inner panel, and reliably temporarily fix the foaming adhesive material to one of the closed cross-section frame portion and inner panel.

In the invention according to claim 12, the inner panel has the shielding wall, and the shielding wall is attached in the direction perpendicular to the longitudinal direction of the closed cross-section frame portion. This makes it possible to prevent deformation of the closed cross section of the closed cross-section frame portion by the shielding wall, and increase the rigidity and strength of the closed cross-section frame portion by the shielding wall.

Furthermore, the recess is formed in one of the joint piece and closed cross-section frame portion, thereby forming the gap between the joint piece and closed cross-section frame portion. By placing the foaming adhesive material in the gap, therefore, the joint piece and closed cross-section frame portion can be joined by the foaming adhesive material.

Accordingly, it is possible to increase portions where the inner panel is joined to the closed cross-section frame portion, and more suitably prevent deformation of the closed cross section of the closed cross-section frame portion by the shielding wall.

In the invention according to claim 13, the closed cross-section frame portion is formed by assembling the at least two outer panels to the first outer panel, and the second outer panels include the dividing portions. Also, each dividing portion includes an overlapping portion. When the overlapping portions are thus formed in the closed cross-section frame portion, it may become difficult to weld the overlapping portions. Therefore, the gap is set between the overlapping portions, and the foaming adhesive material is placed in the gap.

Accordingly, the overlapping portions (that is, the dividing portions) can be adhered by the foaming adhesive material. This makes it possible to reinforce the dividing portions of the second outer panels (that is, the closed cross-section frame portion) by the overlapping portions, thereby increasing the rigidity and strength of the closed cross-section frame portion.

### BRIEF DESCRIPTION OF DRAWINGS

FIG. 1 is a sectional view showing a vehicle body framework structure of the first embodiment according to the present invention;

FIG. 2 is an enlarged view of a portion 2 shown in FIG. 1;

FIG. 3 is a side view showing a state in which a foaming adhesive material of the first embodiment is temporarily fixed to a second outer panel;

FIG. 4 is a perspective view showing the foaming adhesive material shown in FIG. 3;

FIG. 5 is a view for explaining an example of assembling the vehicle body framework structure of the first embodiment;

FIG. 6 is a sectional view showing a vehicle body framework structure of the second embodiment according to the present invention;

FIG. 7 is an enlarged view of a portion 7 shown in FIG. 6;

FIG. 8(a) is a sectional view showing a state in which a foaming adhesive material of the third embodiment according to the present invention is foamed, and FIG. 8(b) is a sectional view showing a state before the foaming adhesive material of the third embodiment foams;

FIG. 9(a) is a side view showing a state in which a foaming adhesive material of the fourth embodiment according to the present invention is temporarily fixed to a second outer panel, and FIG. 9(b) is a perspective view showing the foaming adhesive material of the fourth embodiment;

FIG. 10(a) is a side view showing a state in which a foaming adhesive material of the fifth embodiment according to the present invention is temporarily fixed to a second outer panel, and FIG. 10(b) is a perspective view showing the foaming adhesive material of the fifth embodiment;

FIG. 11(a) is a side view showing a state in which a foaming adhesive material of the sixth embodiment according to the present invention is temporarily fixed to a second outer panel, and FIG. 11(b) is a perspective view showing the foaming adhesive material of the sixth embodiment;

FIG. 12(a) is a side view showing a state in which a foaming adhesive material of the seventh embodiment according to the present invention is temporarily fixed to a second outer panel, FIG. 12(b) is a perspective view showing the foaming adhesive material of the seventh embodiment, and FIG. 12(c) is a sectional view taken along 12c-12c in FIG. 12(a);

FIG. 13(a) is a side view showing a state in which a foaming adhesive material of the eighth embodiment according to the present invention is temporarily fixed to a second outer panel, FIG. 13(b) is a perspective view showing the foaming adhesive material of the eighth embodiment, and FIG. 13(c) is a side view showing a state in which the foaming adhesive material shown in FIG. 13(a) is foamed;

FIG. 14(a) is a side view showing a state in which a foaming adhesive material of the ninth embodiment according to the present invention is temporarily fixed to a second outer panel, FIG. 14(b) is a perspective view showing the foaming adhesive material of the ninth embodiment, and FIG. 14(c) is a side view showing a state in which the foaming adhesive material shown in FIG. 14(a) is foamed;

FIG. 15(a) is a side view showing a state in which a foaming adhesive material of the 10th embodiment according to the present invention is temporarily fixed to a second outer panel, and FIG. 15(b) is a side view showing a state in which the foaming adhesive material of the 10th embodiment is foamed;

FIG. 16 is a perspective view showing a vehicle body side portion including a vehicle body framework structure of the 11th embodiment according to the present invention;

FIG. 17 is a sectional view taken along a line 17-17 in FIG. 16;

FIG. 18 is an exploded perspective view showing the vehicle body side portion of the 11th embodiment;

FIG. 19 is a perspective view showing a fourth inner panel included in the vehicle body framework structure of the 11th embodiment;

FIG. 20 is a perspective view showing a second inner panel and third inner panel included in the vehicle body framework structure of the 11th embodiment;

FIG. 21 is a view for explaining an example of temporarily fixing a foaming adhesive material to the fourth inner panel included in a closed cross-section frame portion of the 11th embodiment;

FIG. 22 is a view for explaining an example of joining the fourth inner panel to the closed cross-section frame portion of the 11th embodiment by the foaming adhesive material;

FIG. 23 is a perspective view showing a vehicle body rear portion including a vehicle body framework structure of the 12th embodiment according to the present invention;

FIG. 24 is a view in the direction of an arrow 24 in FIG. 23;

FIG. 25 is an enlarged view of a portion 25 in FIG. 23;

FIG. 26 is an exploded perspective view showing the vehicle body framework structure in FIG. 25;

FIG. 27 is a sectional view taken along a line 27-27 in FIG. 25;

FIG. 28 is a view for explaining an example of temporarily fixing a foaming adhesive material to a closed cross-section frame portion of the 12th embodiment; and

FIG. 29 is a view for explaining an example of joining the closed cross-section frame portion of the 12th embodiment by the foaming adhesive material.

### DESCRIPTION OF EMBODIMENTS

Best modes for carrying out the present invention will be explained below with reference to the accompanying drawings.

### First Embodiment

A vehicle body framework structure 10 according to the first embodiment will be explained.

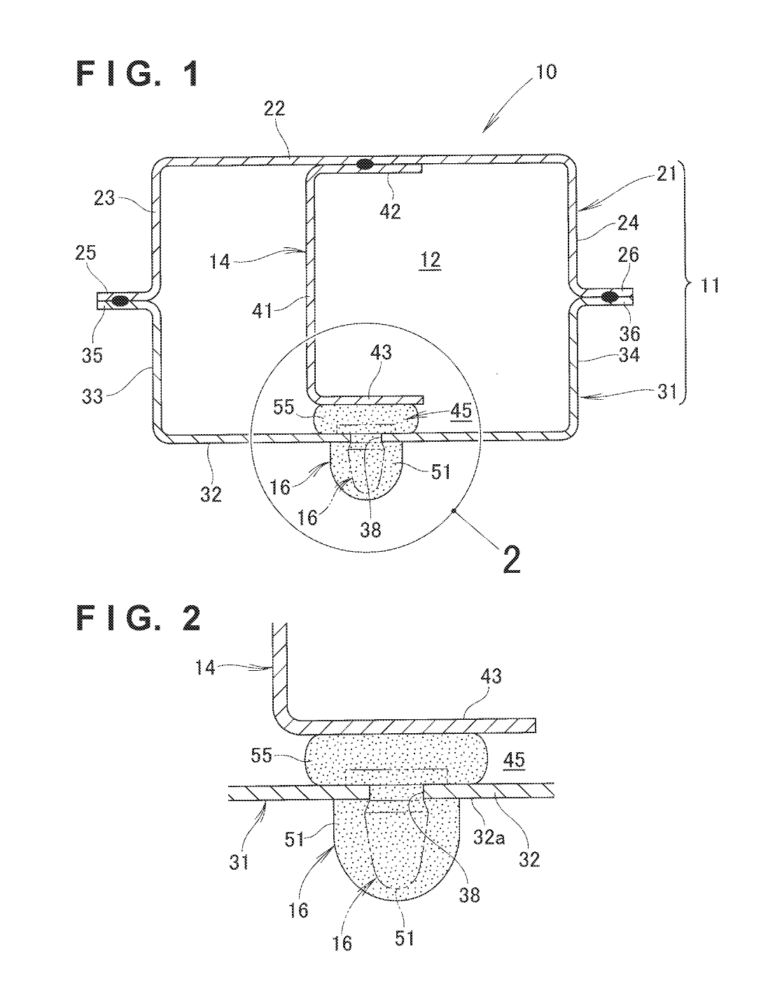

As shown in FIG. 1, the vehicle body framework structure 10 includes a closed cross-section frame portion 11 formed into an almost rectangular framework, an inner panel 14 arranged in a closed cross section 12 of the closed cross-section frame portion 11, and a foaming adhesive material 16 for adhering the inner panel 14 and closed cross-section frame portion 11.

The closed cross-section frame portion 11 includes a first outer panel 21 formed into an almost hat-like cross-sectional shape, and a second outer panel 31 to be joined to the first outer panel 21.

The first outer panel 21 is a metal plate, and includes a first wall portion 22, a first left bent portion 23, a first right bent portion 24, a first left flange 25, and a first right flange 26.

The first wall portion 22 is formed into a flat shape by horizontally extending. The first left bent portion 23 is bent to extend downward from the left end portion of the first wall portion 22. The first right bent portion 24 is bent to extend downward from the right end portion of the first wall portion 22.

The first left flange 25 is bent to overhang leftward from the lower end portion of the first left bent portion 23. The first right flange 26 is bent to overhang rightward from the lower end portion of the first right bent portion 24.

The first wall portion 22, first left bent portion 23, and first right bent portion 24 form a portion having an almost U-shaped cross section. Also, the first outer panel 21 is formed into an almost hat-like cross-sectional shape by the first wall portion 22, first left bent portion 23, first right bent portion 24, first left flange 25, and first right flange 26.

The second outer panel 31 is a member formed to be almost symmetrical with the first outer panel 21 in the vertical direction. The second outer panel 31 is a metal plate, and includes a second wall portion 32, a second left bent portion 33, a second right bent portion 34, a second left flange 35, and a second right flange 36.

The second wall portion 32 is formed into a flat shape by horizontally extending. The second left bent portion 33 is bent to extend upward from the left end portion of the second wall portion 32. The second right bent portion 34 is bent to extend upward from the right end portion of the second wall portion 32.

The second left flange 35 is bent to overhang leftward from the upper end portion of the second left bent portion 33. The second right flange 36 is bent to overhang rightward from the upper end portion of the second right bent portion 34.

An arc-shaped through hole 38 is formed in the second wall portion 32, and the foaming adhesive material 16 is inserted into the through hole 38.

The second wall portion 32, second left bent portion 33, and second right bent portion 34 form a portion having an almost U-shaped cross section. Also, the second outer panel 31 is formed into an almost hat-like cross-sectional shape by the second wall portion 32, second left bent portion 33, second right bent portion 34, second left flange 35, and second right flange 36.

The first left flange 25 and second left flange 35 are joined by spot welding, and the first right flange 26 and second right flange 36 are joined by spot welding. Consequently, the closed cross-section frame portion 11 is formed by the first outer panel 21 and second outer panel 31.

The closed cross section 12 is formed inside the closed cross-section frame portion 11. More specifically, the closed cross section 12 is formed into an almost rectangular shape by the first wall portion 22, first left bent portion 23, first right bent portion 24, second wall portion 32, second left bent portion 33, and second right bent portion 34.

The metal inner panel 14 is arranged in the closed cross section 12 of the closed cross-section frame portion 11.

The inner panel 14 includes a shielding wall 41 vertically extended between the first wall portion 22 and second wall portion 32, an upper joint piece 42 extending to the right from the upper end portion of the shielding wall 41 along the first wall portion 22, and a lower joint piece 43 extending to the right from the lower end portion of the shielding wall 41 along the second wall portion 32.

The inner panel 14 is formed to have an almost U-shaped cross section by the shielding wall 41, upper joint piece 42, and lower joint piece 43. The upper joint piece 42 is joined to the inner surface of the first wall portion 22 by spot welding. A gap 45 is set between the second wall portion 32 and lower joint piece 43.

The gap 45 is set between the second wall portion 32 and lower joint piece 43 for the following reason.

That is, when assembling the vehicle body framework structure 10, the upper joint piece 42 of the inner panel 14 is joined to the first wall portion 22 of the first outer panel 21. In this state, the second left flange 35 of the second outer panel 31 is joined to the first left flange 25 of the first outer panel 21, and the second right flange 36 of the second outer panel 31 is joined to the first right flange 26 of the first outer panel 21.

In this joining step, the lower joint piece 43 of the inner panel 14 may interfere with the second wall portion 32 of the second outer panel 31. Therefore, to avoid the lower joint piece 43 from interfering with the second wall portion 32, the gap 45 is set between the second wall portion 32 and lower joint piece 43.

Since the gap 45 is set between the second wall portion 32 and lower joint piece 43 as described above, the portion where the gap 45 is set is difficult to join by MIG welding or a bolt and nut. In the vehicle body framework structure 10, therefore, joint portions obtained by MIG welding or a bolt and nut are limited.

Accordingly, the gap 45 is filled with a foaming adhesive portion 55 of the foaming adhesive material 16, and the second wall portion 32 and lower joint piece 43 are joined by the foaming adhesive portion 55.

As shown in FIG. 2, the gap 45 between the second wall portion 32 and lower joint piece 43 is filled with the foaming adhesive portion 55 of the foamed foaming adhesive material 16.

Note that the foaming adhesive material 16 indicated by the imaginary lines is an unfoamed foaming adhesive material 16.

When the foaming adhesive material 16 foams from the state indicated by the imaginary lines, the foaming adhesive portion 55 of the foamed foaming adhesive material 16 fills the gap 45. As a consequence, the second wall portion 32 and lower joint piece 43 are joined by the foaming adhesive portion 55.

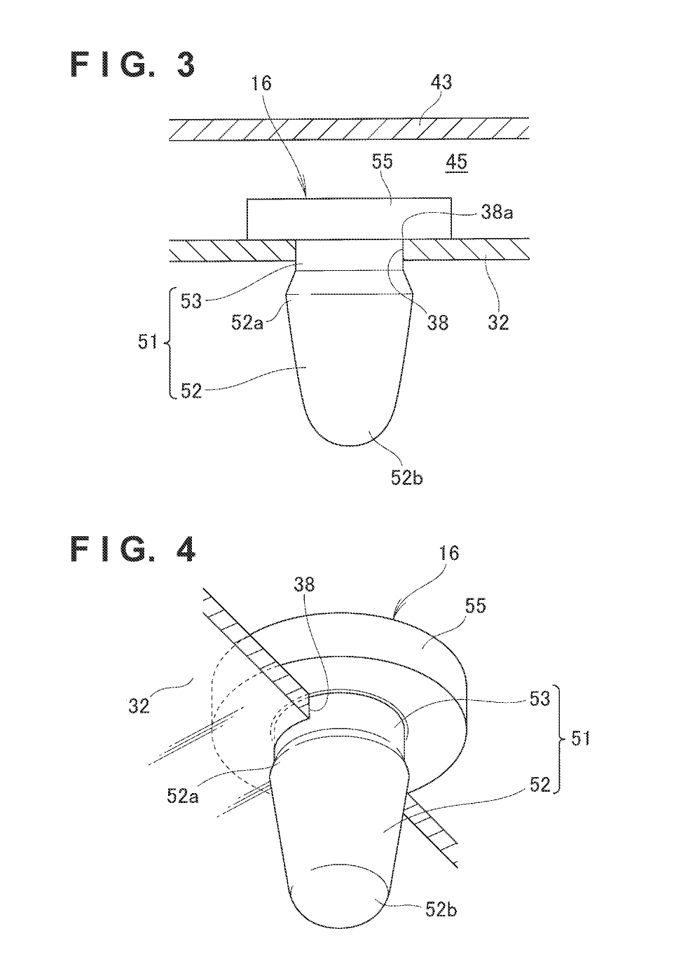

As shown in FIGS. 3 and 4, the foaming adhesive material 16 is formed to have an almost circular cross section, and includes a temporary fixing portion 51 to be inserted into the through hole 38, and the foaming adhesive portion 55 formed in the temporary fixing portion 51. The foaming adhesive material 16 is formed into the shape of a clip by the temporary fixing portion 51 and foaming adhesive portion 55.

In the foaming adhesive material 16, the temporary fixing portion 51 and foaming adhesive portion 55 are integrated by a foaming adhesive.

The foaming adhesive is a molded composition which mainly contains a metal-adhesive resin, and, when foaming by heating, adheres to the second wall portion 32 and lower joint piece 43, and increases the rigidity. This foaming adhesive is an adhesive generally known as a material for adhering metals.

The temporary fixing portion 51 is so formed as to be inserted into the through hole 38 and temporarily fixed in it. The temporary fixing portion 51 includes an insertion portion 52 which can be inserted into the through hole 38, and a fitting portion 53 formed on a proximal portion 52a of the insertion portion 52.

The insertion portion 52 is formed into an inverted truncated conical shape so as to reduce the diameter from the proximal portion 52a to a distal end portion 52b. The distal end portion 52b is formed into a projecting curved surface shape (spherical shape) which projects downward. When inserted into the through hole 38, the insertion portion 52 abuts against an edge 38a of the through hole 38. Since the insertion portion 52 is pressed by the edge 38a, the insertion portion 52 elastically deforms in the direction in which the diameter reduces, and penetrates through the through hole 38.

As described above, the insertion portion 52 can be inserted into the through hole 38 because the distal end portion 52b of the insertion portion 52 is formed into the projecting curved surface shape (spherical shape), and the diameter of the insertion portion 52 of the temporary fixing portion 51 is reduced toward the distal end portion 52b. Accordingly, the insertion portion 52 can easily be inserted into the through hole 38 without any trouble.

This can increase the workability of the work of temporarily fixing the temporary fixing portion 51 (that is, the foaming adhesive material 16) to the second wall portion 32.

The fitting portion 53 is formed on the proximal portion 52a of the insertion portion 52. In addition, the foaming adhesive portion 55 is formed on the fitting portion 53. The fitting portion 53 is formed to be recessed from the foaming adhesive portion 55 and proximal portion 52a so that the fitting portion 53 can be fitted in the through hole 38.

In a state in which the fitting portion 53 is fitted in the through hole 38, the second wall portion 32 is sandwiched between the foaming adhesive portion 55 and proximal portion 52a. Consequently, the temporary fixing portion 51 (more specifically, the foaming adhesive material 16) is temporarily fixed to the second wall portion 32.

In this state, the foaming adhesive portion 55 is arranged in the gap 45 between the second wall portion 32 and lower joint piece 43. The foaming adhesive portion 55 is formed into a circular disk shape having a predetermined thickness and an outer diameter larger than those of the insertion portion 52 and fitting portion 53.

Referring to FIG. 2 again, the foaming adhesive material 16 foams when heated, and the foaming adhesive portion 55 of the foamed foaming adhesive material 16 fills the gap 45. Accordingly, the foamed foaming adhesive portion 55 is adhered to the second wall portion 32 and lower joint piece 43. As a consequence, the second wall portion 32 and lower joint piece 43 are joined by the foamed foaming adhesive portion 55, so the rigidity and strength of the vehicle body framework structure 10 are suitably secured.

Like the foaming adhesive portion 55, the temporary fixing portion 51 is integrated by a foaming adhesive. When inserted into the through hole 38, the temporary fixing portion 51 projects outside from a surface 32a of the second wall portion 32 (that is, from the side opposite to the temporary fixing portion insertion side).

This makes it possible to foam the temporary fixing portion 51 on the surface 32a of the second wall portion 32. Therefore, the surface 32a of the second wall portion 32 can strongly be adhered by the foamed temporary fixing portion 51, so the joint strength between the second wall portion 32 and lower joint piece 43 can further be increased.

Also, the temporary fixing portion 51 and foaming adhesive portion 55 are integrated by a foaming adhesive which increases the rigidity when foaming. That is, the second wall portion 32 and lower joint piece 43 can be joined by the high-rigidity foaming adhesive portion 55.

Accordingly, a load can suitably be transmitted between the closed cross-section frame portion 11 and inner panel 14. This makes it possible to prevent deformation of the closed cross section 12 of the closed cross-section frame portion 11 by the inner panel 14, and increase the rigidity and strength of the closed cross-section frame portion 11 by the inner panel 14.

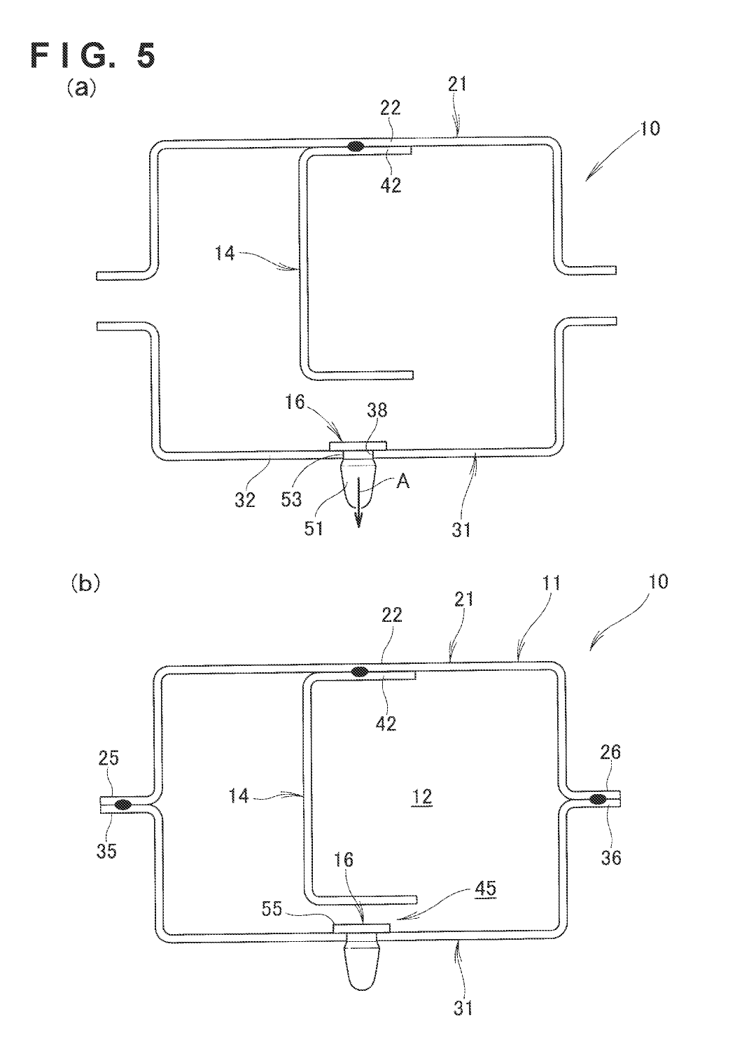

Next, an example of assembling the vehicle body framework structure 10 of the first embodiment will be explained with reference to FIGS. 1 and 5.

As shown in FIG. 5(a), the upper joint piece 42 of the inner panel 14 is abutted against the first wall portion 22 of the first outer panel 21, and the first wall portion 22 and upper joint piece 42 are joined by spot welding.

Then, the temporary fixing portion 51 of the foaming adhesive material 16 is inserted into the through hole 38 of the second outer panel 31 (more specifically, the second wall portion 32) as indicated by an arrow A, thereby fitting the fitting portion 53 in the through hole 38. Accordingly, the foaming adhesive material 16 can temporarily be fixed to the second wall portion 32 in advance.

As shown in FIG. 5(b), in a state in which the first wall portion 22 and upper joint piece 42 are joined, the second left flange 35 of the second outer panel 31 is joined to the first left flange 25 of the first outer panel 21 by spot welding. In addition, the second right flange 36 of the second outer panel 31 is joined to the first right flange 26 of the first outer panel 21 by spot welding.

Consequently, the closed cross-section frame portion 11 is formed by the first outer panel 21 and second outer panel 31, and the closed cross section 12 is formed inside the closed cross-section frame portion 11.

Furthermore, the gap 45 is secured between the second wall portion 32 and lower joint piece 43, and the foaming adhesive portion 55 of the foaming adhesive material 16 is arranged in the gap 45.

As described above, the foaming adhesive portion 55 of the foaming adhesive material 16 can easily be arranged in the gap 45 between the second wall portion 32 and lower joint piece 43 by temporarily fixing the foaming adhesive material 16 to the second wall portion 32 in advance.

As shown in FIG. 1, when the foaming adhesive material 16 is foamed by heating, the foamed foaming adhesive portion 55 is filled in the gap 45. Therefore, the foamed foaming adhesive portion 55 adheres to the second wall portion 55 and lower joint piece 43, and joins the second wall portion 32 and lower joint piece 43.

Since the gap 45 is set between the second wall portion 32 and lower joint piece 43 as described above, portions which are difficult to join by MIG welding or a bolt and nut can be joined by the foaming adhesive portion 55. This makes it possible to suitably secure the rigidity and strength of the vehicle body framework structure 10.

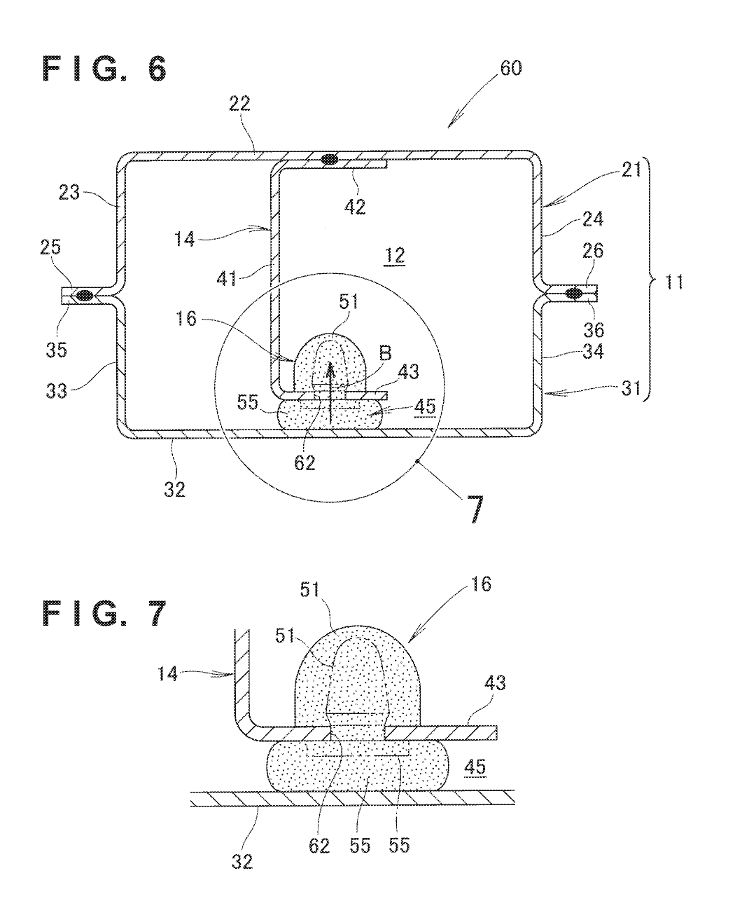

The second to 12th embodiments will be explained below with reference to FIGS. 6 to 29. Note that in the second to 12th embodiments, the same reference numerals as in the first embodiment denote constituent members which are the same as or similar to the members of the first embodiment, and a detailed explanation thereof will be omitted.

First, the second to 10th embodiments will be explained with reference to FIGS. 6 to 15.

### Second Embodiment

A vehicle body framework structure 60 according to the second embodiment will be explained with reference to FIGS. 6 and 7.

As shown in FIGS. 6 and 7, the vehicle body framework structure 60 of the second embodiment has an arrangement in which a foaming adhesive material 16 of the first embodiment is temporarily fixed to a lower joint piece 43 of an inner panel 14. The rest of the arrangement is the same as that of the vehicle body framework structure 10 of the first embodiment.

That is, a through hole 62 is formed in the lower joint piece 43 of the inner panel 14. The foaming adhesive material 16 is temporarily fixed to the lower joint piece 43 by inserting a temporary fixing portion 51 of the foaming adhesive material 16 into the through hole 62 as indicated by an arrow B.

In this state, a second left flange 35 is joined to a first left flange 25 by spot welding, and a second right flange 36 is joined to a first right flange 26 by spot welding. Consequently, a foaming adhesive portion 55 of the foaming adhesive material 16 is arranged in a gap 45.

As described above, the foaming adhesive portion 55 of the foaming adhesive material 16 can easily be arranged in the gap 45 between a second wall portion 32 and the lower joint piece 43 by temporarily fixing the foaming adhesive material 16 to the lower joint piece 43 in advance.

When the foaming adhesive material 16 is foamed by heating, the foamed foaming adhesive portion 55 fills the gap 45, and joins the second wall portion 32 and lower joint piece 43.

Accordingly, the rigidity and strength of the vehicle body framework structure 60 are suitably secured as in the vehicle body framework structure 10 of the first embodiment.

### Third Embodiment

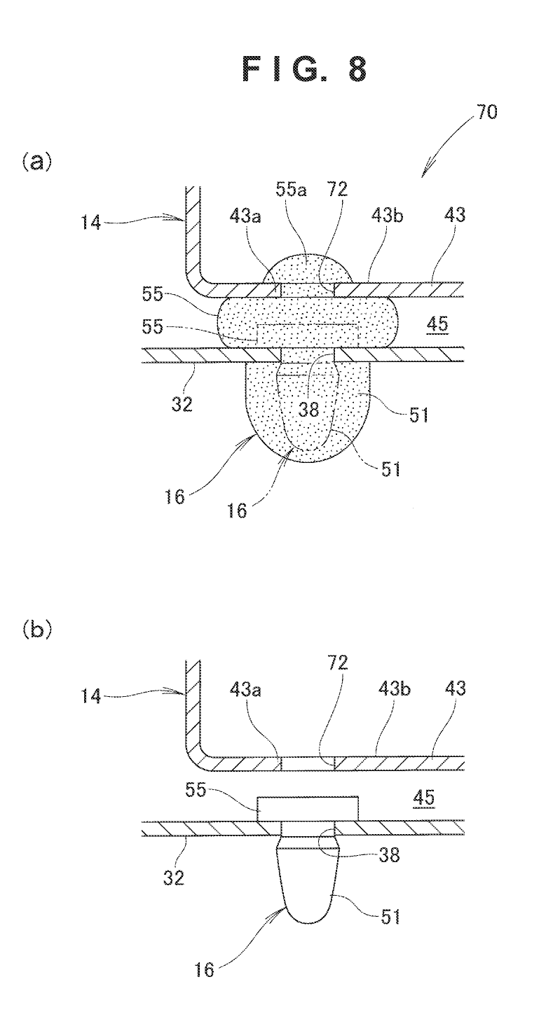

A vehicle body framework structure 70 according to the third embodiment will be explained with reference to FIG. 8.

As shown in FIG. 8, the vehicle body framework structure 70 of the third embodiment has an arrangement in which a guide hole 72 is formed in an inner panel 14 of the first embodiment, and the rest of the arrangement is the same as that of the vehicle body framework structure 10 of the first embodiment.

The guide hole 72 is formed in a lower joint piece 43 of the inner panel 14. The guide hole 72 is arranged in a portion 43a of the lower joint piece 43, which faces a foaming adhesive portion 55.

When the foaming adhesive portion 55 foams, therefore, a portion 55a of the foamed foaming adhesive portion 55 can be guided to a reverse surface 43b of the lower joint piece 43 through the guide hole 72.

Accordingly, the portion 43a facing the foaming adhesive portion 55 can be adhered more strongly by the foamed foaming adhesive portion 55, so the joint strength between a closed cross-section frame portion 11 and the inner panel 14 can further be increased.

Note that when temporarily fixing a foaming adhesive material 16 to the lower joint piece 43 of the inner panel 14 as in the second embodiment, the guide hole 72 is formed in a second wall portion 32 of a second outer panel 31. This makes it possible to adhere the second wall portion 32 more strongly by the foamed foaming adhesive portion 55 as in the third embodiment.

### Fourth Embodiment

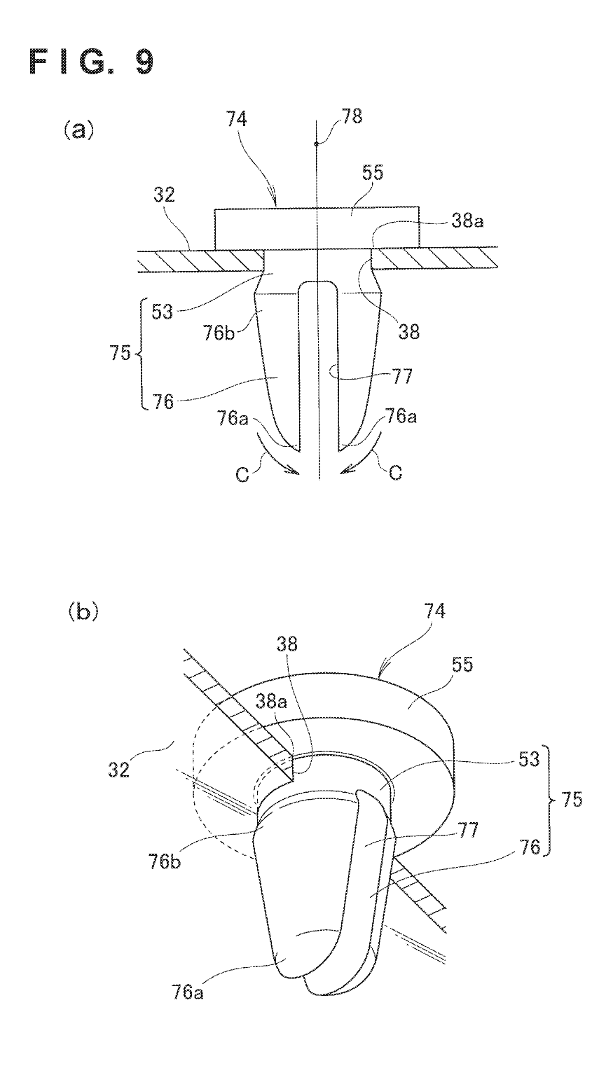

A foaming adhesive material 74 according to the fourth embodiment will be explained with reference to FIG. 9. As shown in FIG. 9, the foaming adhesive material 74 of the fourth embodiment has an arrangement in which a groove 77 is formed in the foaming adhesive material 16 of the first embodiment, and the rest of the arrangement is the same as that of the foaming adhesive material 16 of the first embodiment.

The groove 77 is formed in a temporary fixing portion 75 of the foaming adhesive material 74. The groove 77 is opened in a distal end portion 76a of an insertion portion 76, and extended toward a proximal portion 76b of the insertion portion 76 in the direction of an axis 78 of the foaming adhesive material 74.

When inserting the temporary fixing portion 75 into a through hole 38, therefore, the insertion portion 76 can elastically be deformed toward the groove 77 as indicated by arrows C by causing the insertion portion 76 to interfere with an edge 38a of the through hole 38. This makes it possible to reduce the diameter of the insertion portion 76 in accordance with the through hole 38, and readily insert the temporary fixing portion 75 into the through hole 38.

That is, the workability of the work of temporarily fixing the foaming adhesive material 74 to a second wall portion 32 can be increased.

### Fifth Embodiment

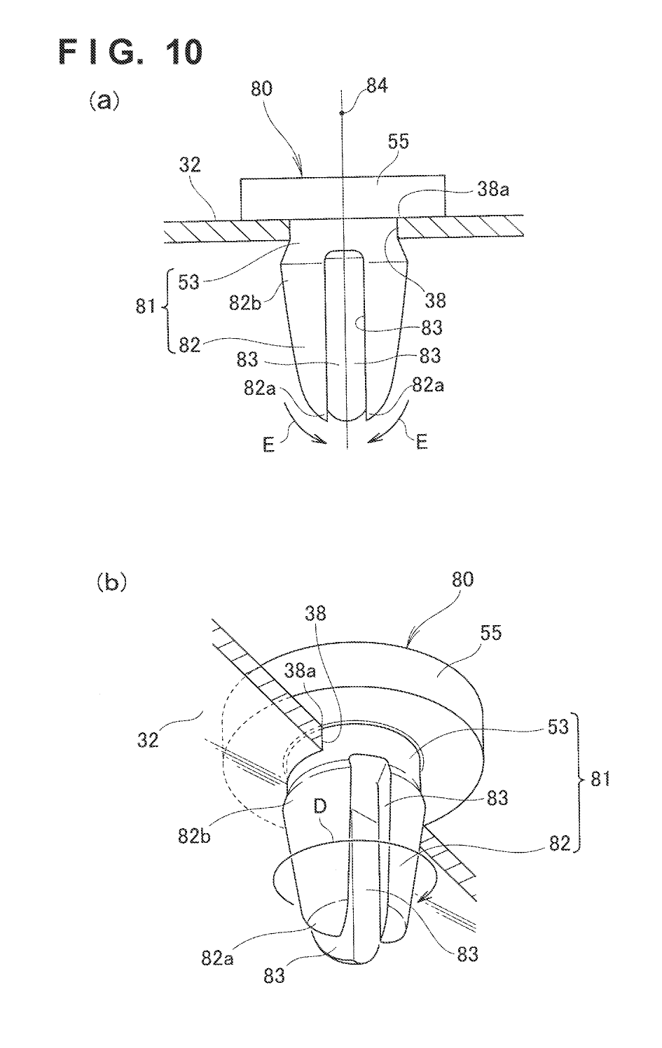

A foaming adhesive material 80 according to the fifth embodiment will be explained with reference to FIG. 10.

As shown in FIG. 10, the foaming adhesive material 80 of the fifth embodiment has an arrangement in which a plurality of grooves 83 are formed in the foaming adhesive material 16 of the first embodiment, and the rest of the arrangement is the same as that of the foaming adhesive material 16 of the first embodiment.

The plurality of grooves 83 are formed in a temporary fixing portion 81 of the foaming adhesive material 80. For example, three grooves 83 are formed at predetermined intervals in the circumferential direction (the direction of an arrow D) of the temporary fixing portion 81. Each groove 83 is opened in a distal end portion 82a of an insertion portion 82, and extended toward a proximal portion 82b of the insertion portion 82 in the direction of an axis 84 of the foaming adhesive material 80.

When inserting the temporary fixing portion 81 into a through hole 38, therefore, the insertion portion 82 can elastically be deformed toward the grooves 83 as indicated by arrows E by causing the insertion portion 82 to interfere with an edge 38a of the through hole 38. This makes it possible to reduce the diameter of the insertion portion 82 in accordance with the through hole 38, and readily insert the temporary fixing portion 81 into the through hole 38.

That is, the workability of the work of temporarily fixing the foaming adhesive material 80 to a second wall portion 32 can be increased.

Note that in the fifth embodiment, the example in which the three grooves 83 are formed in the temporary fixing portion 81 has been explained. However, the present invention is not limited to this, and it is also possible to form a plurality of grooves 83 which are not three in the temporary fixing portion 81.

### Sixth Embodiment

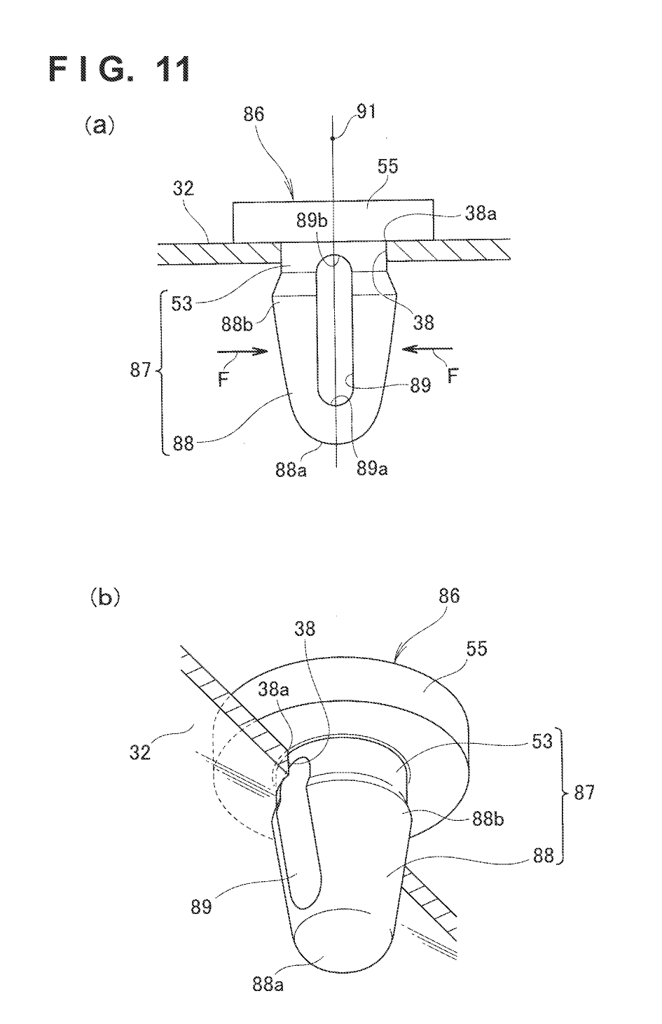

A foaming adhesive material 86 according to the sixth embodiment will be explained with reference to FIG. 11.

As shown in FIG. 11, the foaming adhesive material 86 of the sixth embodiment has an arrangement in which a slit 89 is formed in the foaming adhesive material 16 of the first embodiment, and the rest of the arrangement is the same as that of the foaming adhesive material 16 of the first embodiment.

The slit 89 is formed in a temporary fixing portion 87 of the foaming adhesive material 86. The slit 89 is formed into a long hole by being extended in the direction of an axis 91 of the foaming adhesive material 86, and opened in a direction perpendicular to the direction of the axis 91.

A lower end portion 89a of the slit 89 is formed near a distal end portion 88a of an insertion portion 88, and the distal end portion 88a of the insertion portion 88 is formed into a projecting curved surface shape (spherical shape). Also, an upper end portion 89b of the slit 89 is formed near a proximal portion 88b of the insertion portion 88, and extended to a fitting portion 53.

Since the distal end portion 88a of the insertion portion 88 is formed into the projecting curved surface shape, the distal end portion 88a of the insertion portion 88 can easily be inserted into a through hole 38.

In addition, when inserting the temporary fixing portion 87 into the through hole 38, the insertion portion 88 can elastically be deformed toward the slit 89 as indicated by arrows F by causing the insertion portion 88 to interfere with an edge 38a of the through hole 38. This makes it possible to reduce the diameter of the insertion portion 88 in accordance with the through hole 38, and readily insert the temporary fixing portion 87 into the through hole 38.

That is, the workability of the work of temporarily fixing the foaming adhesive material 86 to a second wall portion 32 can be increased.

### Seventh Embodiment

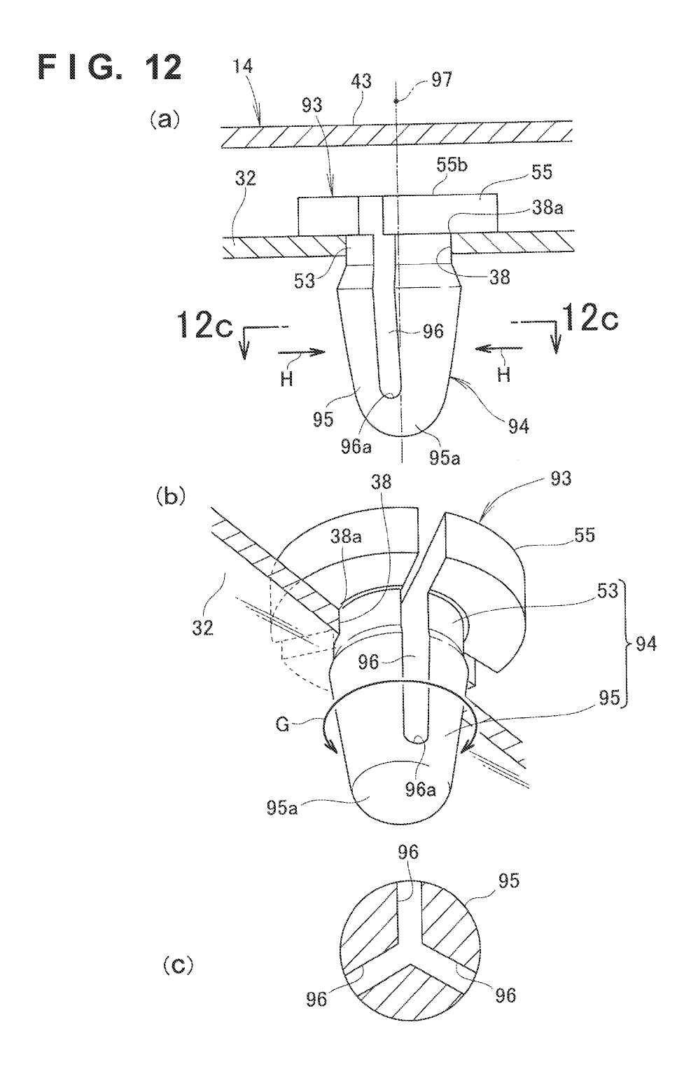

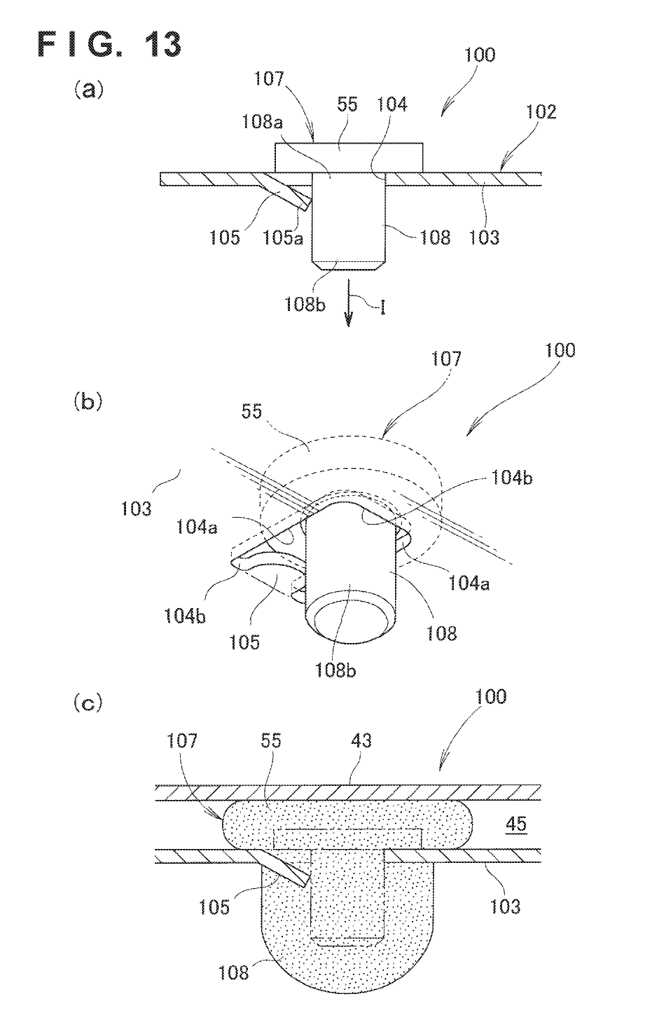

A foaming adhesive material 93 according to the seventh embodiment will be explained with reference to FIG. 12.

As shown in FIG. 12, the foaming adhesive material 93 of the seventh embodiment has an arrangement in which a plurality of slits 96 are formed in the foaming adhesive material 16 of the first embodiment, and the rest of the arrangement is the same as that of the foaming adhesive material 16 of the first embodiment.

The plurality of slits 96 are formed in a temporary fixing portion 94 of the foaming adhesive material 93. For example, three slits 96 are formed at predetermined intervals in the circumferential direction (the direction of an arrow G) of the temporary fixing portion 94.

Each slit 96 is extended to a foaming adhesive portion 55 in the direction of an axis 97 of the foaming adhesive material 93, and opened in a direction perpendicular to the direction of the axis 97. In addition, since each slit 96 is extended to the foaming adhesive portion 55, a hole is formed by the slit 96 in a surface 55b of the foaming adhesive portion 55, which opposes a lower joint piece 43. That is, the foaming adhesive portion 55 is divided into a plurality of portions by the slits 96.

Also, a lower end portion 96a of each slit 96 is formed near a distal end portion 95a of an insertion portion 95, and the distal end portion 95a of the insertion portion 95 is formed into a projecting curved surface shape (spherical shape). Accordingly, the distal end portion 95a of the insertion portion 95 can easily be inserted into a through hole 38.

Furthermore, the foaming adhesive portion 55 is divided into the plurality of portions by the slits 96. When inserting the temporary fixing portion 94 into the through hole 38, therefore, a fitting portion 53 and the foaming adhesive portion 55 can be moved toward the slits 96 together with the insertion portion 95.

Consequently, the diameter of the fitting portion 53 can be reduced in accordance with the through hole 38, so the temporary fixing portion 94 can easily be inserted into the through hole 38 even when the diameter of the through hole 38 is decreased.

The rigidity and strength of a second wall portion 32 (that is, a closed cross-section frame portion 11) can be increased by decreasing the diameter of the through hole 38.

In addition, since the diameter of the fitting portion 53 is reduced in accordance with the through hole 38, it is possible to more reliably prevent removal of the foaming adhesive material 93 from the through hole 38, and prevent shaky fitting of the foaming adhesive material 93.

### Eighth Embodiment

A vehicle body framework structure 100 according to the eighth embodiment will be explained with reference to FIG. 13.

As shown in FIGS. 13(a) and 13(b), the vehicle body framework structure 100 of the eighth embodiment has an arrangement in which the second outer panel 31 and foaming adhesive material 16 of the first embodiment are replaced with a second outer panel 102 and a foaming adhesive material 107, and the rest of the arrangement is the same as that of the vehicle body framework structure 10 of the first embodiment.

The second outer panel 102 is a metal plate, a through hole 104 is formed in a second wall portion 103, and a locking piece 105 projects into the through hole 104 from the edge of the through hole 104. The through hole 104 is formed into an almost rectangular shape by a pair of long sides 104a and a pair of short sides 104b. The locking piece 105 extends from one short side 104b toward the other short side 104b so as to be elastically deformable.

A temporary fixing portion 108 of the foaming adhesive material 107 is inserted into the through hole 104. The temporary fixing portion 108 is formed into a columnar shape having a uniform outer diameter from a proximal portion 108a to a distal end portion 108b. Since the temporary fixing portion 108 is formed into the columnar shape, the shape of the foaming adhesive material 107 can be simplified.

The foaming adhesive material 107 is formed into the shape of a clip by the temporary fixing portion 108 and a foaming adhesive portion 55.

When the temporary fixing portion 108 of the foaming adhesive material 107 is inserted into the through hole 104 as indicated by an arrow I, the temporary fixing portion 108 abuts against (interferes with) a distal end portion 105a of the locking piece 105. In this state, the temporary fixing portion 108 is inserted into the through hole 104, and the locking piece 105 elastically deforms in the insertion direction of the temporary fixing portion 108.

As described above, the temporary fixing portion 108 elastically deforms the locking piece 105 when inserted into the through hole 104, so the temporary fixing portion 108 can easily be inserted into the through hole 104.

Also, since the temporary fixing portion 108 is inserted into the through hole 104 by elastically deforming the locking piece 105, the temporary fixing portion 108 (that is, the foaming adhesive material 107) can be formed by using a hard foaming adhesive.

Furthermore, the locking piece 105 is kept abutting against the temporary fixing portion 108 inserted into the through hole 104. This makes it possible to prevent removal of the temporary fixing portion 108 from the through hole 104 by the locking piece 105, and reliably temporarily fix the columnar temporary fixing portion 108 in the through hole 104.

As shown in FIG. 13(c), when the foaming adhesive material 107 is foamed by heating, the foamed foaming adhesive portion 55 fills a gap 45, and joins the second wall portion 103 and a lower joint piece 43.

Accordingly, the rigidity and strength of the vehicle body framework structure 100 are suitably secured like those of the vehicle body framework structure 10 of the first embodiment.

Note that in the eighth embodiment, the example in which the locking piece 105 is elastically deformed has been explained. However, the present invention is not limited to this, and it is also possible to keep the locking piece 105 abutting against the temporary fixing portion 108 by plastically deforming the locking piece 105.

### Ninth Embodiment

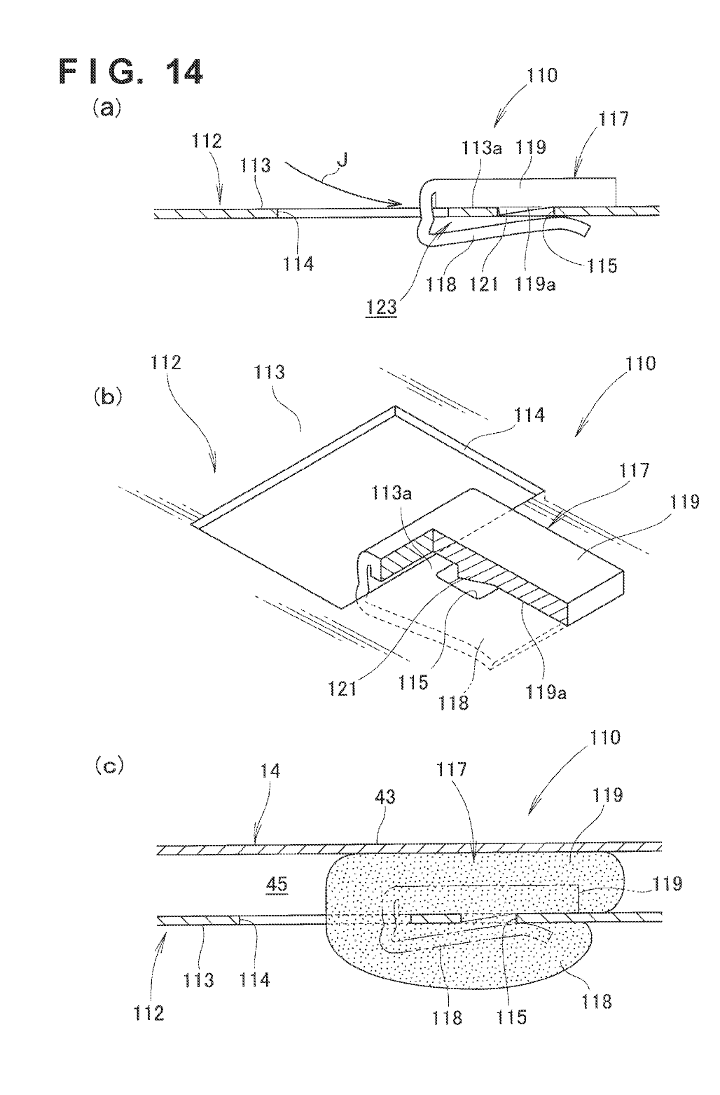

A vehicle body framework structure 110 according to the ninth embodiment will be explained with reference to FIG. 14.

As shown in FIGS. 14(a) and 14(b), the vehicle body framework structure 110 of the ninth embodiment has an arrangement in which the second outer panel 31 and foaming adhesive material 16 of the first embodiment are replaced with a second outer panel 112 and a foaming adhesive material 117, and the rest of the arrangement is the same as that of the vehicle body framework structure 10 of the first embodiment.

The second outer panel 112 is a metal plate, an almost rectangular opening 114 is formed in a second wall portion 113, and an almost rectangular engaging hole 115 is formed in a vicinity 113a of the opening 114.

A temporary fixing portion 118 and a foaming adhesive portion 119 of the foaming adhesive material 117 are formed into the shape of a clip having an almost U shape when viewed sideways, and a clip gap 123 is secured between the temporary fixing portion 118 and foaming adhesive portion 119. When the second wall portion 113 of the second outer panel 112 is fitted in the clip gap 123, the second wall portion 113 is sandwiched between the temporary fixing portion 118 and foaming adhesive portion 119.

The foaming adhesive portion 119 has a pawl 121 which projects toward the temporary fixing portion 118 from a surface 119a which faces the temporary fixing portion 118.

The second wall portion 113 is fitted in the clip gap 123 between the temporary fixing portion 118 and foaming adhesive portion 119 by moving the foaming adhesive material 117 from the opening 114 to the engaging hole 115 as indicated by an arrow J. By moving the foaming adhesive material 117 in this state as indicated by the arrow J, the second wall portion 113 can be sandwiched between the temporary fixing portion 118 and foaming adhesive portion 119.

The pawl 121 engages with the engaging hole 115 by continuously sliding the foaming adhesive material 117 as indicated by the arrow J. This makes it possible to readily attach the foaming adhesive material 117 to the second wall portion 113, and reliably temporarily fix the foaming adhesive material 117 to the second wall portion 113. By joining the second outer panel 112 to a first inner panel 14 (see FIG. 14(c)) in this state, the foaming adhesive portion 119 is arranged in a gap 45 (see FIG. 14(c)).

As described above, when temporarily fixing the foaming adhesive material 117, the deformation amount of the temporary fixing portion 118 can be decreased by fitting the second wall portion 113 in the clip gap 123 between the temporary fixing portion 118 and foaming adhesive portion 119.

Accordingly, the temporary fixing portion 118 (that is, the foaming adhesive material 117) can be formed by using a hard foaming adhesive.

As shown in FIG. 14(c), when the foaming adhesive material 117 is foamed by heating, the foamed foaming adhesive portion 119 fills the gap 45, and joins the second wall portion 113 and a lower joint piece 43.

Consequently, the rigidity and strength of the vehicle body framework structure 110 are suitably secured like those of the vehicle body framework structure 10 of the first embodiment.

Note that in the ninth embodiment, the example in which the foaming adhesive material 117 is temporarily fixed by clipping the second wall portion 113 of the second outer panel 112 has been explained. However, the present invention is not limited to this, and it is also possible to temporarily fix the foaming adhesive 117 by clipping the lower joint piece 43 of the inner panel 14.

Note also that in the ninth embodiment, the example in which the pawl 121 is formed on the foaming adhesive portion 119 has been explained. However, the present invention is not limited to this, and the pawl 121 may also be formed on the temporary fixing portion 118.

### 10th Embodiment

A foaming adhesive material 125 according to the 10th embodiment will be explained with reference to FIG. 15.

As shown in FIG. 15(a), a temporary fixing portion 126 and a foaming adhesive portion 127 of the foaming adhesive material 125 of the 10th embodiment are formed by different members.

The temporary fixing portion 126 is formed by a soft material such as a resin. Therefore, when inserting the temporary fixing portion 126 into a through hole 38 of a second wall portion 32 as indicated by an arrow K, the temporary fixing portion 126 can easily be deformed by abutting it against an edge 38a of the through hole 38.

This makes it possible to readily insert the temporary fixing portion 126 into the through hole 38 of the second wall portion 32, and increase the workability of the work of temporarily fixing the foaming adhesive material 125 to the second wall portion 32.

The foaming adhesive portion 127 is formed on a head 126a of the temporary fixing portion 126. As in the first embodiment, the foaming adhesive portion 127 is integrated by a foaming adhesive.

The foaming adhesive is a molded composition which mainly contains a metal-adhesive resin, and foams when heated, thereby adhering to the second wall portion 32 and a lower joint piece 43, and increasing the rigidity.

As shown in FIG. 15(b), when the foaming adhesive portion 127 is foamed by heating, the foamed foaming adhesive portion 127 fills the gap 45, and joins the second wall portion 32 and lower joint piece 43.

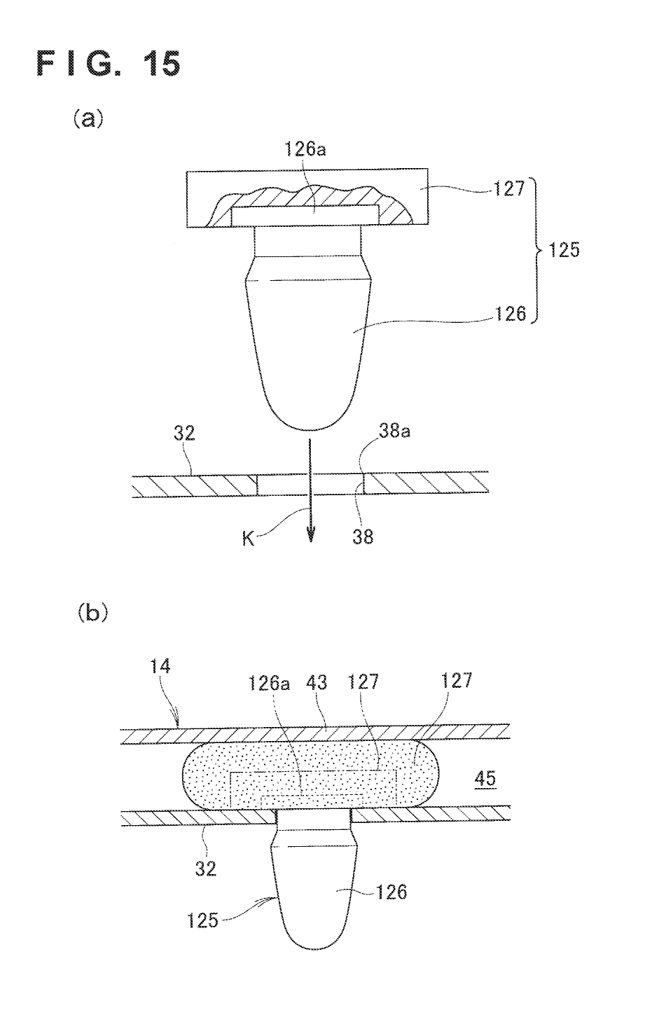

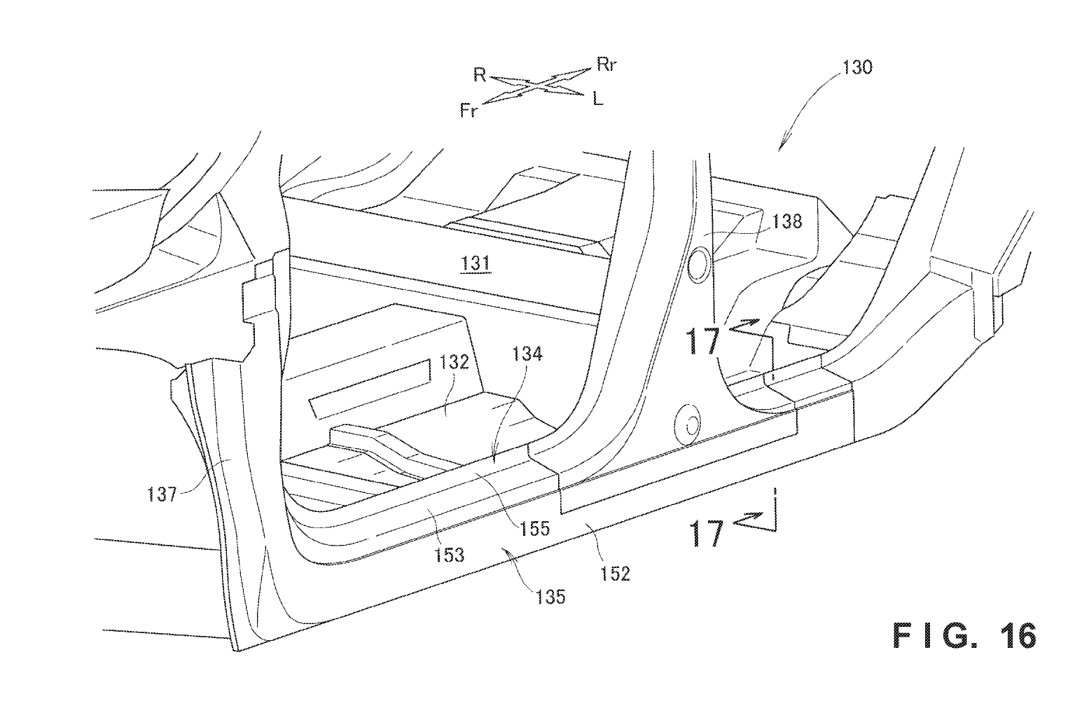

Next, the 11th and 12th embodiments will be explained with reference to FIGS. 16 to 29. Note that in FIGS. 16 to 29, “front (Fr)”, “rear (Rr)”. “left (L)”, and “right (R)” are directions viewed from the driver.

### 11th Embodiment

A vehicle body framework structure 134 according to the 11th embodiment will be explained with reference to FIGS. 16 to 20.

In a vehicle body side portion 130 as shown in FIG. 16, the floor of an interior 131 is formed by a floor panel 132, and the side portion of the floor panel 132 is supported by the vehicle body framework structure 134. The vehicle body framework structure 134 is a side sill for ensuring the rigidity and strength of the vehicle body side portion 130 by reinforcing the lower portion of the vehicle body side portion 130.

A front pillar 137 stands from the front end portion of the vehicle body framework structure 134. A center pillar 138 stands from the middle portion of the vehicle body framework structure 134.

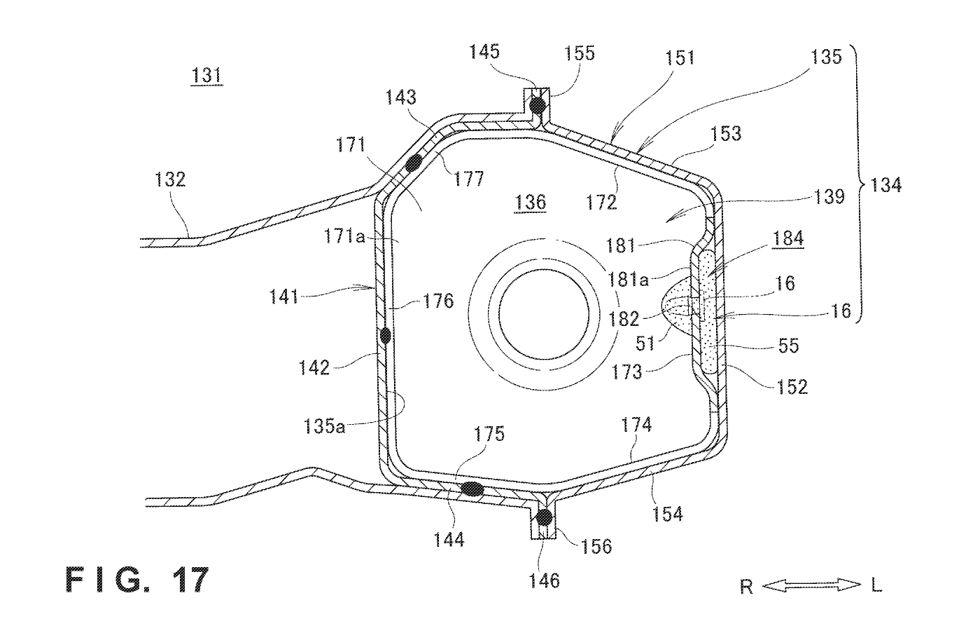

As shown in FIG. 17, the vehicle body framework structure 134 includes a closed cross-section frame portion 135 formed into an almost rectangular framework, inner panels 139 arranged in a closed cross section 136 of the closed cross-section frame portion 135, and a foaming adhesive material 16 for adhering the inner panels 139 and closed cross-section frame portion 135.

The closed cross-section frame portion 135 includes a first outer panel 141 formed to have an almost hat-like cross section, and a second outer panel 151 joined to the first outer panel 141.

The first outer panel 141 is a metal plate, and includes a first wall portion 142, a first upper bent portion 143, a first lower bent portion 144, a first upper flange 145, and a first lower flange 146.

The first wall portion 142 stands into a flat shape by vertically extending. The first upper bent portion 143 is bent to extend outward from the upper end portion of the first wall portion 142. The first lower bent portion 144 is bent to extend outward from the lower end portion of the first wall portion 142.

The first upper flange 145 is bent to overhang upward from the outer end portion of the first upper bent portion 143. The first lower flange 146 is bent to overhang downward from the outer end portion of the first lower bent portion 144.

The first wall portion 142, first upper bent portion 143, and first lower bent portion 144 form a portion having an almost U-shaped cross section. Also, the first outer panel 141 is formed to have an almost hat-like cross section by the first wall portion 142, first upper bent portion 143, first lower bent portion 144, first upper flange 145, and first lower flange 146.

The second outer panel 151 is a member formed to be almost symmetrical with the first outer panel 141 in the horizontal direction. The second outer panel 151 is a metal plate, and includes a second wall portion 152, a second upper bent portion 153, a second lower bent portion 154, a second upper flange 155, and a second lower flange 156.

The second wall portion 152 stands into a flat shape by vertically extending. The second upper bent portion 153 is bent to extend inward from the upper end portion of the second wall portion 152. The second lower bent portion 154 is bent to extend inward from the lower end portion of the second wall portion 152.

The second upper flange 155 is bent to overhang upward from the inner end portion of the second upper bent portion 153. The second lower flange 156 is bent to overhang downward from the inner end portion of the second lower bent portion 154.

The second wall portion 152, second upper bent portion 153, and second lower bent portion 154 form a portion having an almost U-shaped cross section. Also, the second outer panel 151 is formed to have an almost hat-like cross section by the second wall portion 152, second upper bent portion 153, second lower bent portion 154, second upper flange 155, and second lower flange 156.

The first upper flange 145 and second upper flange 155 are joined by spot welding, and the first lower flange 146 and second lower flange 156 are joined by spot welding. Consequently, the closed cross-section frame portion 135 of the side sill is formed by the first outer panel 141 and second outer panel 151.

The closed cross section 136 is formed inside the closed cross-section frame portion 135. More specifically, the closed cross section 136 is formed into an almost rectangular shape by the first wall portion 142, first upper bent portion 143, first lower bent portion 144, second wall portion 152, second upper bent portion 153, and second lower bent portion 154.

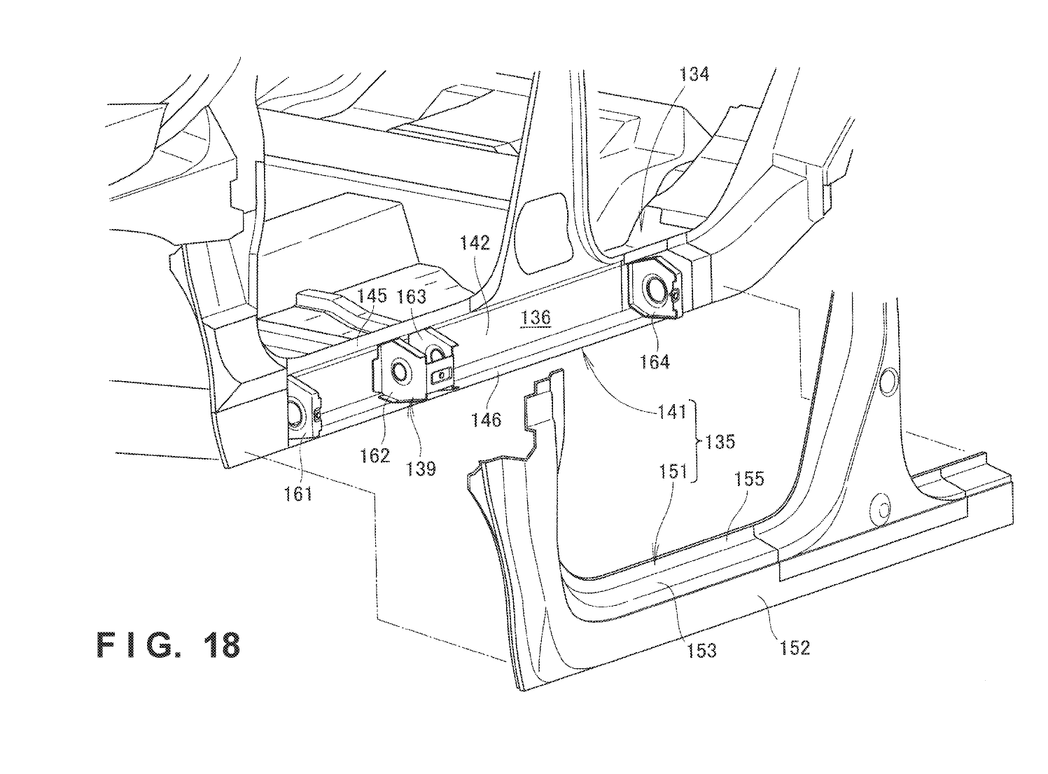

As shown in FIG. 18, the metal inner panels 139 are arranged in the closed cross section 136 of the closed cross-section frame portion 135. The inner panels 139 include a first inner panel 161 arranged in the front end portion of the closed cross section 136, a second inner panel 162 and a third inner panel 163 arranged behind the first inner pane 161 in the direction of the vehicle body rear side, and a fourth inner panel 164 arranged behind the third inner panel 163 in the direction of the vehicle body rear side.

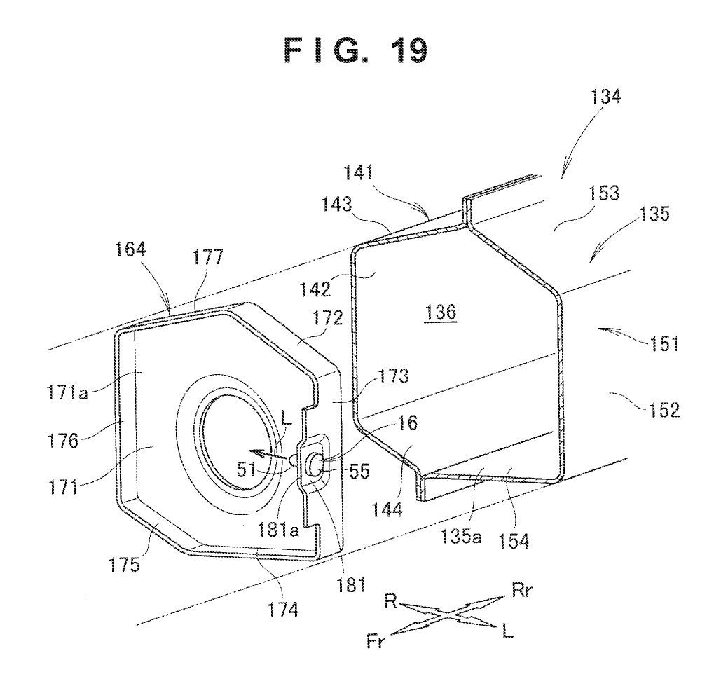

As shown in FIGS. 17 and 19, the fourth inner panel 164 includes a shielding wall 171 arranged to be perpendicular to the longitudinal direction (that is, the vehicle body front-rear direction) of the closed cross-section frame portion 135, and first to sixth joint pieces 172 to 177 extending from an outer edge 171a of the shielding wall 171.

The shielding wall 171 is arranged in the closed cross section 136 of the closed cross-section frame portion 135 so as to be perpendicular to the longitudinal direction, and the outer edge 171a is formed into an almost hexagonal shape along an inner surface 135a of the closed cross-section frame portion 135. The first to sixth joint pieces 172 to 177 are bent to project toward the vehicle body front side from the outer edge 171a of the shielding wall 171 along the inner surface 135a of the closed cross-section frame portion 135.

The sixth joint piece 177 is joined to the first upper bent portion 143 by spot welding. The fifth joint piece 176 is joined to the first wall portion 142 by spot welding. The fourth joint piece 175 is joined to the first lower bent portion 144 by spot welding.

The second joint piece 173 is projected along the second wall portion 152 of the closed cross-section frame portion 135, and has a recess 181. The recess 181 is formed to be recessed toward the center of the closed cross section 136 such that a bottom portion 181a is spaced apart from the second wall portion 152. Consequently, a gap 184 is formed between the recess 181 (particularly, the bottom portion 181a of the recess 181) and the second wall portion 152.

An arc-shaped through hole 182 is formed in the bottom portion 181a of the recess 181, and the foaming adhesive material 16 is inserted into the through hole 182 from outside the vehicle as indicated by an arrow L. The foaming adhesive material 16 is temporarily fixed to the recess 181 (more specifically, the bottom portion 181a) by being inserted into the through hole 182.

In this state, the foaming adhesive material 16 foams by heating, and a foaming adhesive portion 55 of the foamed foaming adhesive material 16 fills the gap 184. The foamed foaming adhesive portion 55 is adhered to the recess 181 and second wall portion 152. As a consequence, the recess 181 and second wall portion 152 are joined by the foamed foaming adhesive portion 55.

The shielding wall 171 of the fourth inner panel 164 is attached to be perpendicular to the longitudinal direction of the closed cross-section frame portion 135. This makes it possible to prevent deformation of the closed cross section 136 of the closed cross-section frame portion 135 by the shielding wall 171, and increase the rigidity and strength of the closed cross-section frame portion 135 by the shielding wall 171.

Furthermore, since the recess 181 and second wall portion 152 are joined by the foaming adhesive portion 55, a portion where the fourth inner panel 164 is joined to the closed cross-section frame portion 135 can be added to the joint portions formed by spot welding.

Accordingly, it is possible to suitably prevent deformation of the closed cross section 136 of the closed cross-section frame portion 135 by the shielding wall 171 (that is, the fourth inner panel 164), and suitably ensure the rigidity and strength of the vehicle body framework structure (that is, the side sill) 134.

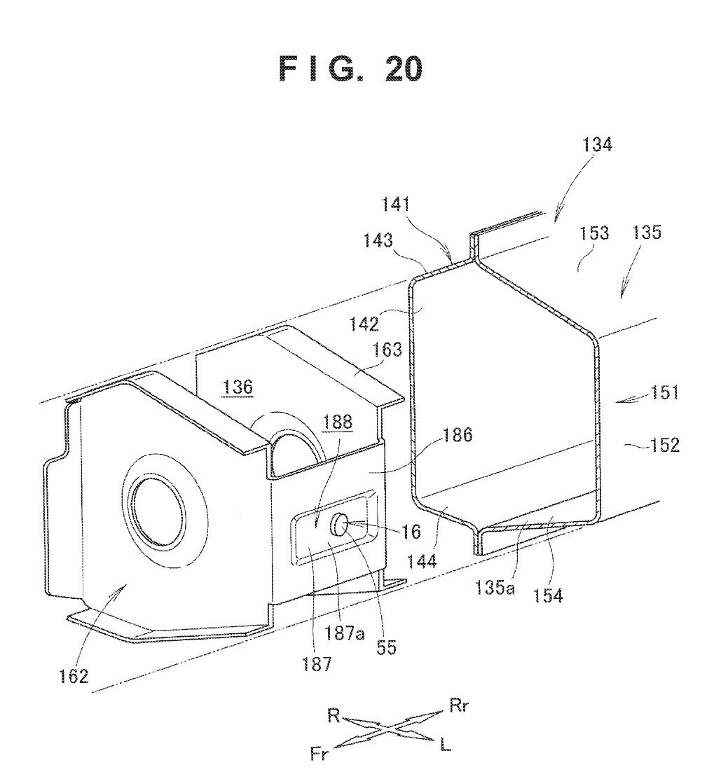

As shown in FIG. 20, the second inner panel 162 and third inner panel 163 are connected by a second joint piece 186.

The second inner panel 162 and third inner panel 163 are similar to the fourth inner panel 164 except for the second joint piece 186. Therefore, the second joint piece 186 of the second inner panel 162 and third inner panel 163 will be explained below, and an explanation of the rest will be omitted.

Like the second joint piece 173 of the fourth inner panel 164, the second joint piece 186 is projected along the second wall portion 152 of the closed cross-section frame portion 135, and has a recess 187. Like the recess 181 of the fourth inner panel 164, the recess 187 is formed into a recess toward the center of the closed cross section 136 so that a bottom portion 187a is spaced apart from the second wall portion 152. Consequently, a gap 188 is formed between the recess 187 (particularly, the bottom portion 187a of the recess 187) and the second wall portion 152.

An arc-shaped through hole (not shown) is formed in the bottom portion 181a of the recess 181, and the foaming adhesive material 16 is inserted into this through hole from outside the vehicle. The foaming adhesive material 16 is temporarily fixed to the recess 187 (more specifically, the bottom portion 187a) by being inserted into the through hole.

In this state, the foaming adhesive material 16 foams by heating, and the foaming adhesive portion 55 of the foamed foaming adhesive material 16 fills the gap 188. The foamed foaming adhesive portion 55 is adhered to the recess 187 and second wall portion 152. Accordingly, the recess 187 and second wall portion 152 are joined by the foamed foaming adhesive portion 55.

This makes it possible to suitably secure the rigidity and strength of the vehicle body framework structure (that is, the side sill) 134 by the second inner panel 162 and third inner panel 163.

Referring to FIG. 18 again, the first inner panel 161 is similar to the fourth inner panel 164, so an explanation of the first inner panel 161 will be omitted.

Like the second to fourth inner panels 162 to 164, the first inner panel 161 can also suitably secure the rigidity and strength of the vehicle body framework structure (that is, the side sill) 134.

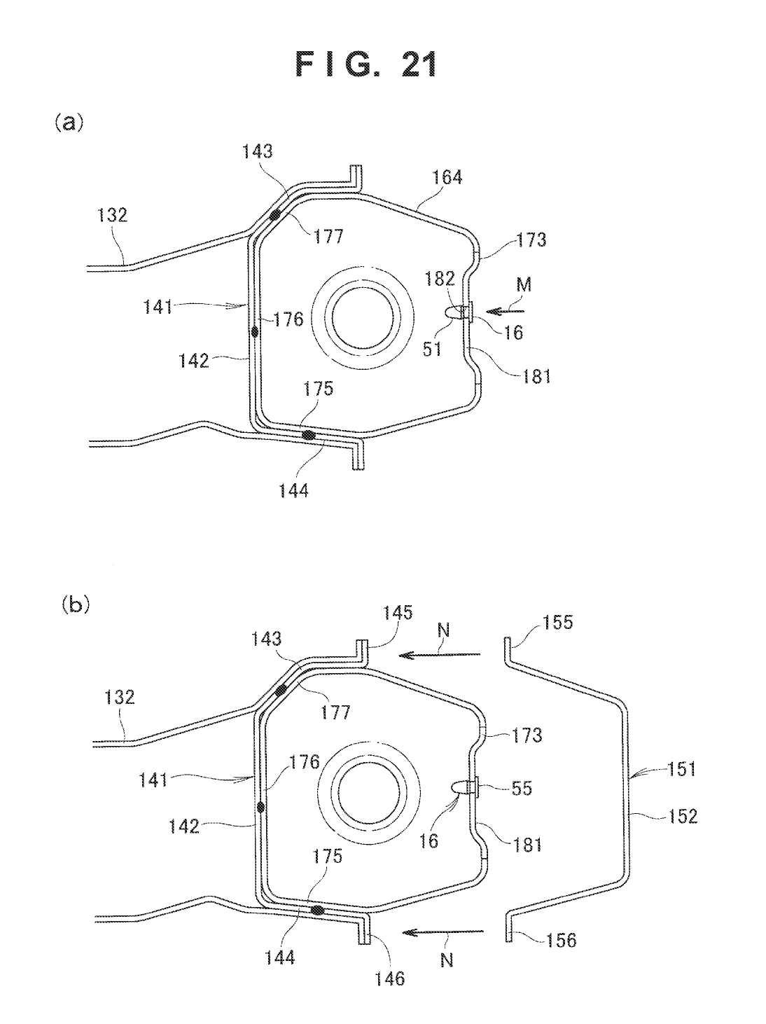

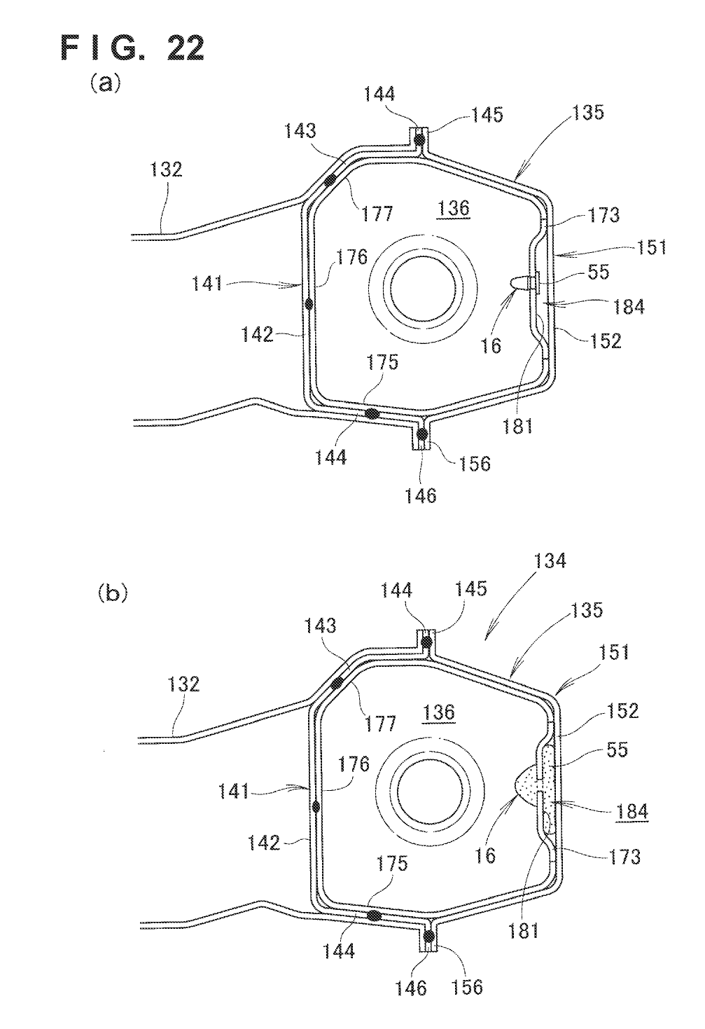

Next, an example of joining the fourth inner panel 164 to the closed cross-section frame portion 135 of the 11th embodiment will be explained with reference to FIGS. 21 and 22.

As shown in FIG. 21(a), the fifth joint piece 176 of the fourth inner panel 164 is joined to the first wall portion 142 of the first outer panel 141 by spot welding. Also, the sixth joint piece 177 is joined to the first upper bent portion 143 by spot welding. In addition, the fourth joint piece 175 is joined to the first lower bent portion 144 by spot welding. Furthermore, a temporary fixing portion 51 of the foaming adhesive material 16 is inserted into the through hole 182 formed in the recess 181 of the second joint piece 173 as indicated by an arrow M, thereby temporarily fixing the foaming adhesive material 16 to the recess 181.

As shown in FIG. 21(b), the second upper flange 155 of the second outer panel 151 is abutted against the first upper flange 145 of the first outer panel 141 as indicated by an arrow N. In addition, the second lower flange 156 of the second outer panel 151 is abutted against the first lower flange 146 of the first outer panel 141 as indicated by an arrow N.

As shown in FIG. 22(a), the second upper flange 155 of the second outer panel 151 is joined to the first upper flange 145 of the first outer panel 141 by spot welding. In addition, the second lower flange 156 of the second outer panel 151 is joined to the first lower flange 146 of the first outer panel 141 by spot welding.

Accordingly, the closed cross-section frame portion 135 is formed by the first outer panel 141 and second outer panel 151, and the closed cross section 136 is formed inside the closed cross-section frame portion 135.

Furthermore, the gap 184 is secured between the second wall portion 152 and recess 181, and the foaming adhesive portion 55 of the foaming adhesive material 16 is arranged in the gap 184. By temporarily fixing the foaming adhesive material 16 to the recess 181 in advance, the foaming adhesive portion 55 of the foaming adhesive material 16 can easily be arranged in the gap 184 between the second wall portion 152 and recess 181.

As shown in FIG. 22(b), when the foaming adhesive material 16 is foamed by heating, the foamed foaming adhesive portion 55 fills the gap 184. Therefore, the foamed foaming adhesive portion 55 adheres to the second wall portion 152 and recess 181, and joins the second wall portion 152 and recess 181.

This makes it possible to suitably secure the rigidity and strength of the vehicle body framework structure (that is, the side sill) 134.

Note that in the 11th embodiment, the example in which the gap 184 is formed between the second joint piece 173 and the second wall portion 152 of the closed cross-section frame portion 135 by forming the recess 181 in the second joint piece 173 has been explained. However, the present invention is not limited to this, and it is also possible to form a gap between the second wall portion 152 and second joint piece 173 by forming a recess in the second wall portion 152.

Alternatively, a gap can be formed between the second joint piece 173 and second wall portion 152 by spacing the second joint piece 173 apart from the second wall portion 152.

### 12th Embodiment

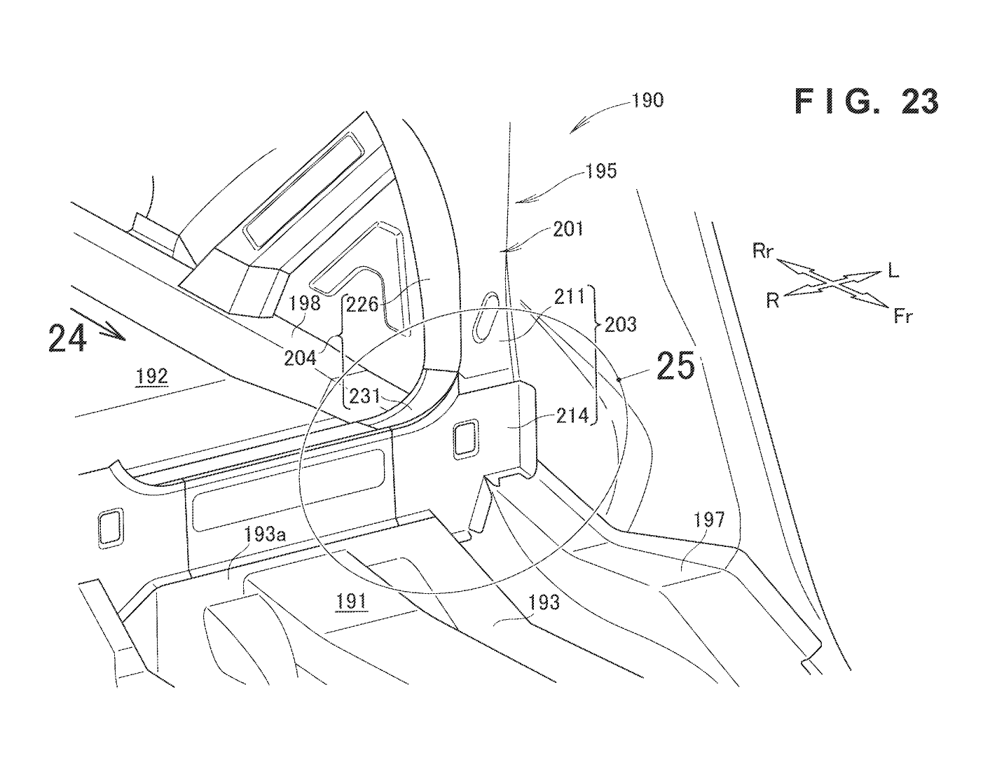

A vehicle body framework structure 195 according to the 12th embodiment will be explained with reference to FIGS. 23 to 27.

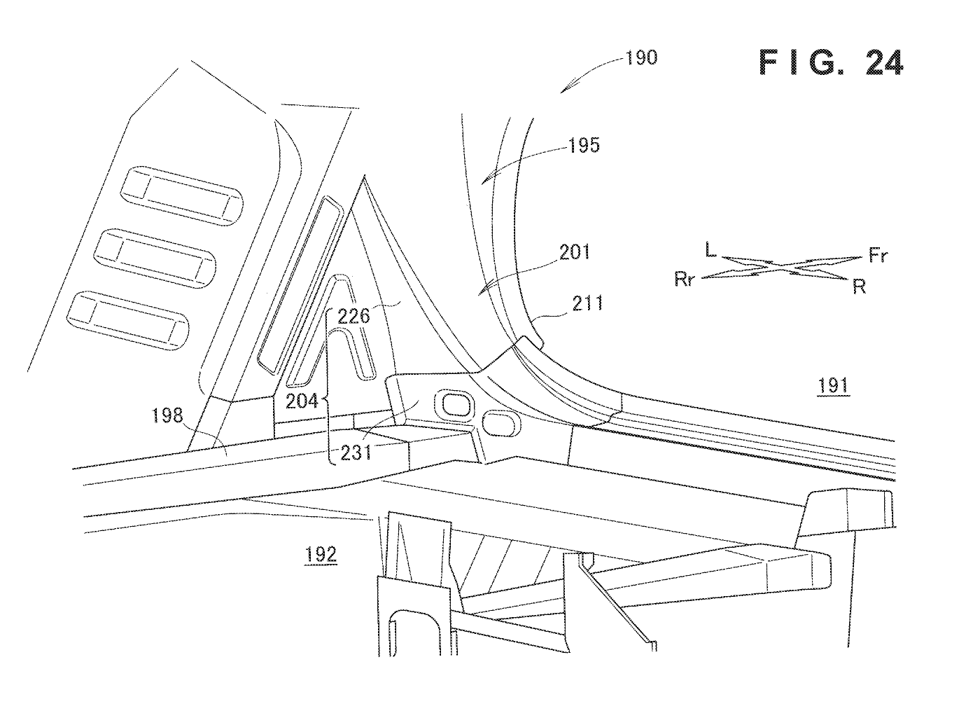

As shown in FIGS. 23 and 24, in a vehicle body rear portion 190, the floor of an interior 191 is formed by a floor panel 193, and a read end portion 193a of the floor panel 193 is supported by the vehicle body framework structure 195. The vehicle body framework structure 195 is a rear bulkhead for assuring the rigidity and strength of the vehicle body rear portion 190 by reinforcing it.

A side sill 197 is formed on the vehicle body front side of the vehicle body framework structure 195, and a rear floor frame 198 is formed on the vehicle body rear side of the vehicle body framework structure 195.

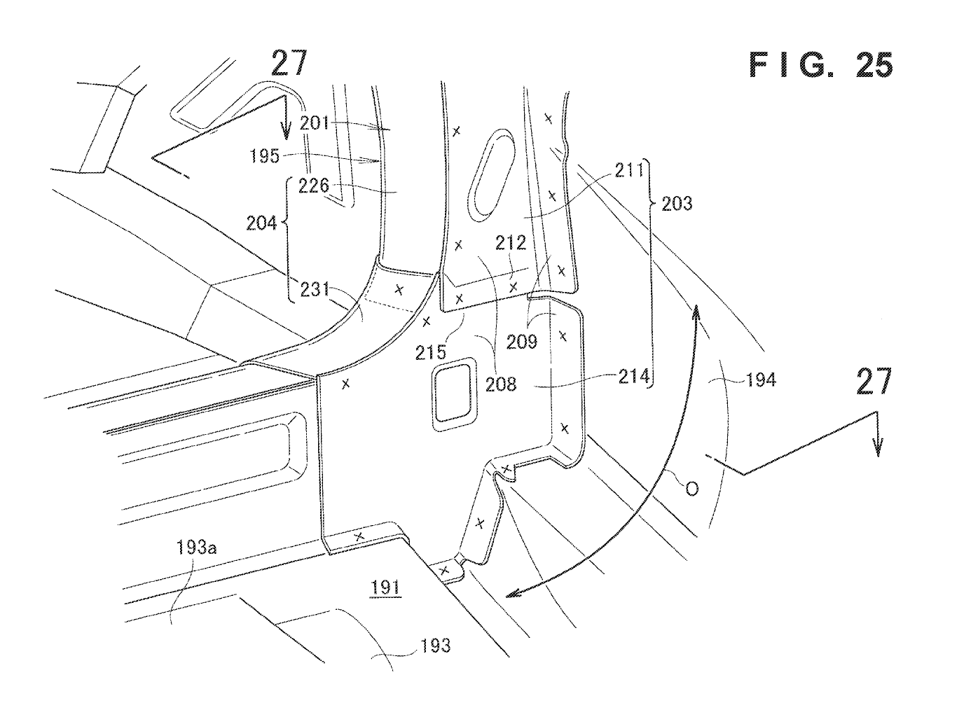

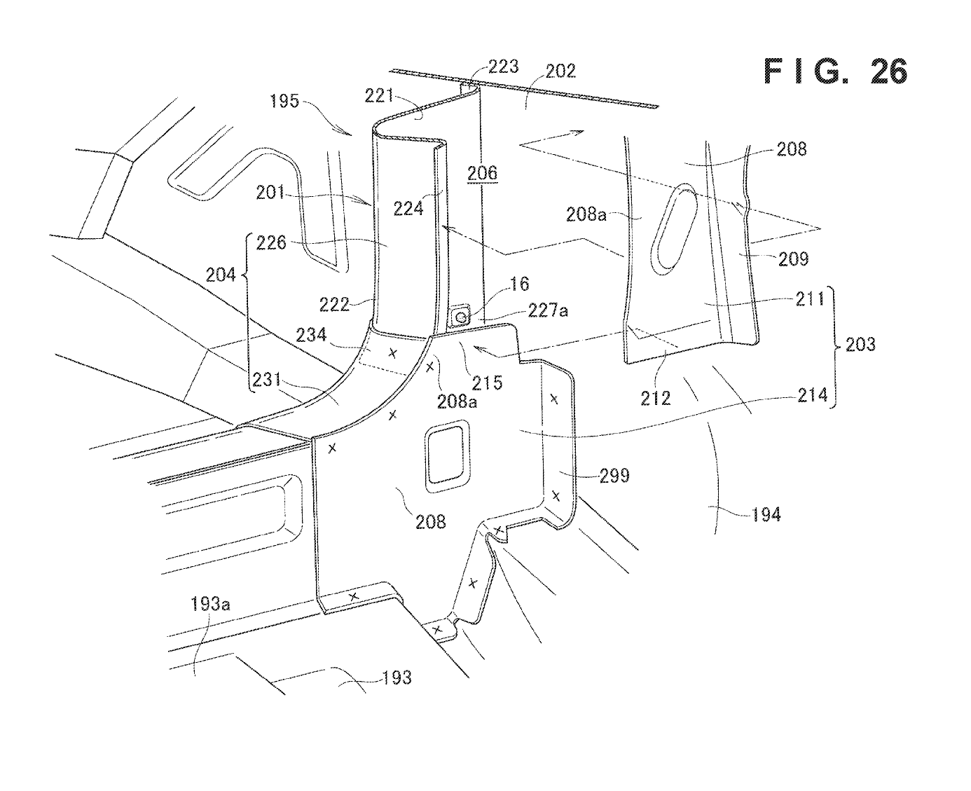

As shown in FIGS. 25 and 26, the vehicle body framework structure 195 includes a hollow closed cross-section frame portion 201 formed into an almost rectangular framework, and a foaming adhesive material 16 for adhering the closed cross-section frame portion 201.

The closed cross-section frame portion 201 is formed into an almost L shape when viewed frontways by being extended leftward in the vehicle widthwise direction to a wheelhouse 194 along the rear end portion 193a of the floor panel 193, and extended upward along the wheelhouse 194.

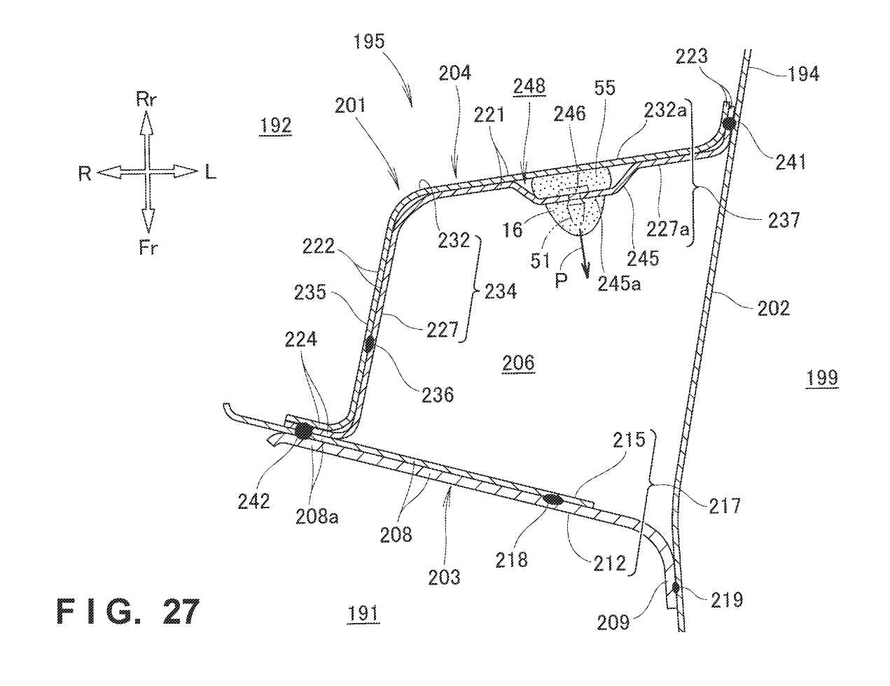

As shown in FIGS. 26 and 27, the closed cross-section frame portion 201 includes a first outer panel 202 facing an outside 199, a second interior-side outer panel (second outer panel) 203 joined to the first outer panel 202 and facing the interior 191, and a second trunk-side outer panel (second outer panel) 204 joined to the first outer panel 202 and facing a trunk room 192.

An almost rectangular closed cross section 206 is formed inside the closed cross-section frame portion 201 by assembling the first outer panel 202, second interior-side outer panel 203, and second trunk-side outer panel 204 (that is, a plurality of outer panels) by joining them.

The first outer panel 202 is an almost flat portion forming a part of the wheelhouse 194 (more specifically, an inner wheelhouse).

The second interior-side outer panel 203 is extended into an almost L shape when viewed frontways (see also FIG. 25), and formed to have an almost flat cross section. The second interior-side outer panel 203 includes a second interior wall portion 208 facing the interior 191, and a second interior flange 209 bent from the outer end portion of the second interior wall portion 208 to the vehicle front side along the first outer panel 202.

The second interior-side outer panel 203 is divided into a second upper interior panel 211 and second lower interior panel 214 in the longitudinal direction (the direction of an arrow O (see FIG. 25)) of the closed cross-section frame portion 201. The second upper interior panel 211 has a second upper interior dividing portion 212 in the lower end portion. The second lower interior panel 214 has a second lower interior dividing portion 215 in the upper end portion.

The second upper interior dividing portion 212 is overlapped on the second lower interior dividing portion 215 from the interior 191.

The second trunk-side outer panel 204 is extended into an almost L shape when viewed frontways, and formed to have an almost V-shaped cross section.

The second trunk-side outer panel 204 includes a second trunk rear wall portion 221 facing the vehicle body rear side of the trunk room 192, a second trunk inner wall portion 222 bent from the inner end portion of the second trunk rear wall portion 221 to the vehicle body front side and facing the inside of the trunk room 192, a second trunk rear flange 223 bent from the outer end portion of the second trunk rear wall portion 221 to the vehicle body rear side along the first outer panel 202, and a second trunk inner flange 224 bent from the front end portion of the second trunk inner wall portion 222 to the inside in the vehicle widthwise direction along an inner end portion 208a of the second interior wall portion 208.

The second trunk-side outer panel 204 is divided into a second upper trunk panel 226 (an inner panel) and a second lower trunk panel 231 in the longitudinal direction (the direction of the arrow O (see FIG. 25)) of the closed cross-section frame portion 201. The second upper trunk panel 226 has a second upper trunk dividing portion (inner panel) 227 in the lower end portion. The second lower trunk panel 231 has a second lower trunk dividing portion 232 in the upper end portion.

The second lower trunk dividing portion 232 is overlapped on the second upper trunk dividing portion 227 from the trunk room 192.

By overlapping the second upper interior dividing portion 212 of the second upper interior panel 211 on the second lower interior dividing portion 215 of the second lower interior panel 214 from the interior 191, interior overlapping portions 217 are formed by the second upper interior dividing portion 212 and second lower interior dividing portion 215. The interior overlapping portions 217 are joined in a joint portion 218 by MIG welding.

Consequently, the second interior flange 203 is formed by joining the second upper interior panel 211 and second lower interior panel 214. The second interior flange 209 of the second interior-side outer panel 203 and the first outer panel 202 are jointed in a joint portion 219 by spot welding.

By overlapping the second lower trunk dividing portion 232 of the second lower trunk panel 231 on the second upper trunk dividing portion 227 of the second upper trunk panel 226 from the trunk room 192, trunk overlapping portions 234 are formed by the second upper trunk dividing portion 227 and second lower trunk dividing portion 232.

Inner overlapping portions 235 of the trunk overlapping portions 234, which are on the inside of the trunk room 192, are joined in a joint portion 236 by MIG welding. Also, rear overlapping portions 237 of the trunk overlapping portions 234, which are on the rear side of the trunk room 192, are joined by the foaming adhesive material 16.

Accordingly, the second trunk-side outer panel 204 is formed by joining the second upper trunk panel 226 and second lower trunk panel 231. The second trunk rear flange 223 of the second trunk-side outer panel 204 and the first outer panel 202 are joined in a joint portion 241 by spot welding.

Also, the second trunk inner flange 224 of the second trunk-side outer panel 204 and the inner end portion 208a of the second interior-side outer panel 203 (more specifically, the second interior wall portion 208) are joined in a joint portion 242 by spot welding.

The closed cross-section frame portion 201 is formed by assembling the first outer panel 202, second interior-side outer panel 203, and second trunk-side outer panel 204 by joining them.

The rear overlapping portions 237 of the trunk overlapping portions 234 will be explained in detail below. Note that the rear overlapping portions 237 are portions facing the rear side of the trunk room 192, so it is difficult to bring, for example, a MIG welding tool to the rear overlapping portions 237. This makes it difficult to join the rear overlapping portions 237 by MIG welding. Therefore, the rear overlapping portions 237 is joined by the foaming adhesive material 16.

That is, the rear overlapping portions 237 include an upper rear portion 227a of the second upper trunk dividing portion 227, which is on the rear side of the trunk room 192, and a lower rear portion 232a of the second lower trunk dividing portion 232, which is on the rear side of the trunk room 192.

A recess 245 is formed in the upper rear portion 227a. The recess 245 is formed into a recessed shape toward the center of the closed cross section 206 so that a bottom portion 245a is spaced apart from the lower rear portion 232a. Consequently, a gap 248 is formed between the recess 245 (particularly, the bottom portion 245a of the recess 245) and the lower rear portion 232a.

An arc-like through hole 246 is formed in the bottom portion 245a of the recess 245, and the foaming adhesive material 16 is inserted into the through hole 246 from the rear side of the trunk room 192 as indicated by an arrow P. The foaming adhesive material 16 is temporarily fixed to the recess 245 (more specifically, the bottom portion 245a) by being inserted into the through hole 246.

In this state, the foaming adhesive material 16 foams by heating, and a foaming adhesive portion 55 of the foaming adhesive material 16 fills the gap 248. The foamed foaming adhesive portion 55 is adhered to the recess 245 and lower rear portion 232a. The recess 245 is formed in the upper rear portion 227a.

Since, therefore, the recess 245 and lower rear portion 232a are joined by the foamed foaming adhesive portion 55, the upper rear portion 227a and lower rear portion 232a (that is, the rear overlapping portions 237) are joined. Consequently, the rear overlapping portions 237 reinforce the second upper trunk dividing portion 227 and second lower trunk dividing portion 232 of the second trunk-side outer panel 204, thereby increasing the rigidity and strength of the closed cross-section frame portion 201.

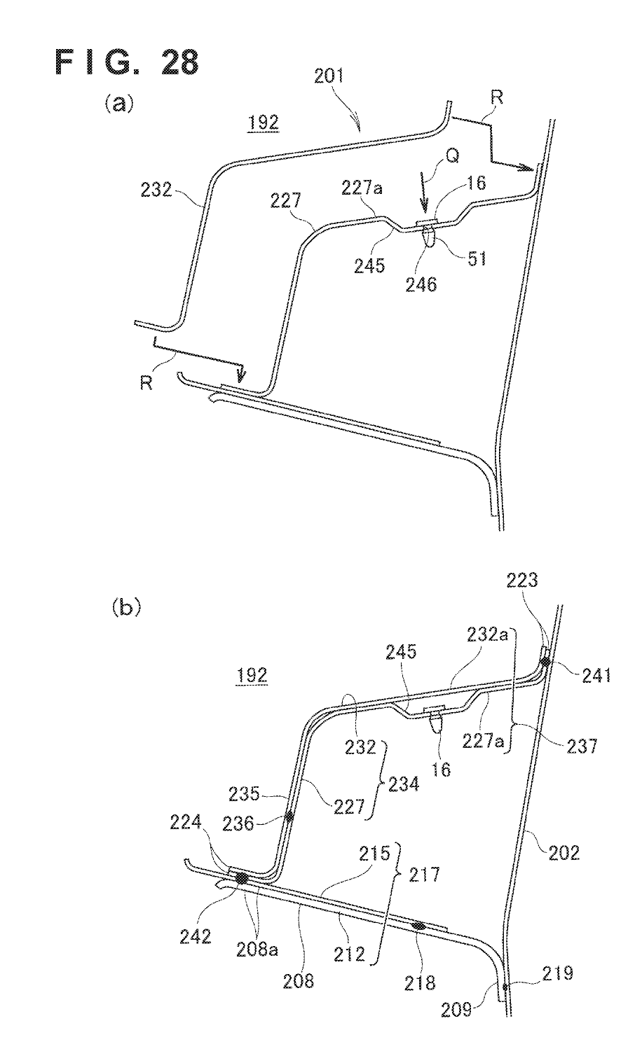

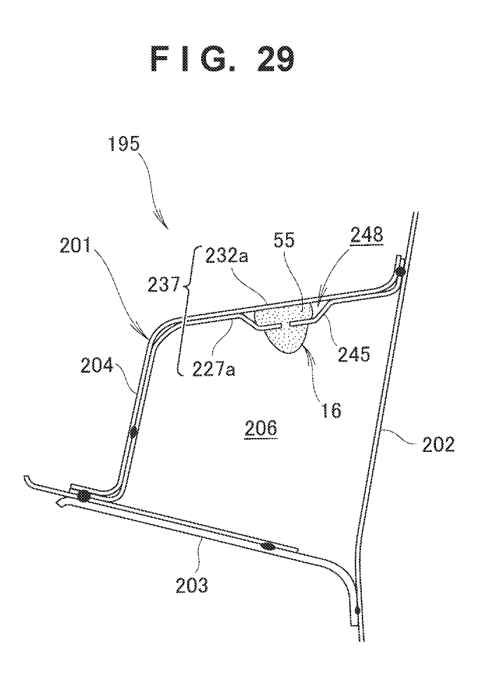

Next, an example of joining the closed cross-section frame portion 201 of the 12th embodiment will be explained with reference to FIGS. 28 and 29.

As shown in FIG. 28(a), the through hole 246 is formed in the recess 245 of the upper rear portion 227a of the second upper trunk dividing portion 227. A temporary fixing portion 51 of the foaming adhesive material 16 is inserted into the through hole 246 from the rear side of the trunk room 192 as indicated by an arrow Q. Since the temporary fixing portion 51 is inserted into the through hole 246, the foaming adhesive material 16 is temporarily fixed to the recess 245.

In a state in which the foaming adhesive material 16 is temporarily fixed to the recess 245, the second lower trunk dividing portion 232 is overlapped on the second upper trunk dividing portion 227 as indicated by an arrow R.

As shown in FIG. 28(b), the interior overlapping portions 217 of the second lower interior dividing portion 215 and second upper interior dividing portion 212 are joined in the joint portion 218 by MIG welding. Also, the second interior flange 209 and first outer panel 202 are joined by spot welding in the joint portion 219.

Furthermore, of the trunk overlapping portions 234 of the second upper trunk dividing portion 227 and second lower trunk dividing portion 232, the inner overlapping portions 235 on the inside of the trunk room 192 are joined in the joint portion 236 by MIG welding. Also, the second trunk rear flange 223 and first outer panel 202 are joined in the joint portion 241 by spot welding.

In addition, the second trunk inner flange 224 and the inner end portion 208a of the second interior wall portion 208 are joined in the joint portion 242 by spot welding.

The upper rear portion 227a and lower rear portion 232a of the rear overlapping portions 237 are portions difficult to join by MIG welding or the like. Therefore, the foaming adhesive material 16 is temporarily fixed to the recess 245 of the upper rear portion 227a, and the rear overlapping portions 237 are joined by the foaming adhesive material 16.

As shown in FIG. 29, the foaming adhesive material 16 is foamed by heating, and the gap 248 is filled by the foaming adhesive portion 55 of the foamed foaming adhesive material 16. Since, therefore, the recess 245 and lower rear portion 232a (that is, the rear overlapping portions 237) are joined by the foamed foaming adhesive portion 55, the upper rear portion 227a and lower rear portion 232a (that is, the rear overlapping portions 237) are joined.

As described above, even when the rear overlapping portions 237 are difficult to join by MIG welding or the like, the rear overlapping portions 237 can be joined by the foaming adhesive material 16. Consequently, it is possible to strongly assemble the first outer panel 202, second interior-side outer panel 203, and second trunk-side outer panel 204, and secure the rigidity of the closed cross-section frame portion 201.

Note that in the 12th embodiment, the example in which the gap 248 is formed between the rear overlapping portions 237 by forming the recess 245 in the upper rear portion 227a has been explained. However, the present invention is not limited to this, and it is also possible to form a gap between the rear overlapping portions 237 by forming a recess in the lower rear portion 232a.

Alternatively, it is possible to form a gap between the rear overlapping portions 237 by spacing the upper rear portion 227a apart from the lower rear portion 232a.

Note that the vehicle body framework structure according to the present invention is not limited to the above-described embodiments, and can appropriately be changed and modified.

For example, the shapes and arrangements of the vehicle body framework structures, closed cross-section frame portions, closed cross sections, inner panels, foaming adhesive materials, first and second outer panels, through holes, gaps, temporary fixing portions, insertion portions, fitting portions, foaming adhesive portions, guide holes, grooves, slits, locking pieces, engaging holes, first to fourth inner panels, shielding walls, first to sixth joint pieces, recesses, second interior-side outer panels, second trunk-side outer panels, second upper and lower interior dividing portions, interior overlapping portions, second upper and lower trunk dividing portions, and trunk overlapping portions are not limited to the exemplary members, and can appropriately be changed.

### INDUSTRIAL APPLICABILITY

The present invention is suitably applicable to an automobile including a vehicle body framework structure in which a closed cross-section frame portion is formed by a plurality of outer panels, and an inner panel is installed in a closed cross section of the closed cross-section frame portion.

### REFERENCE SIGNS LIST

10, 60, 70, 100, 110, 134, 195 . . . vehicle body framework structure
11, 135, 201 . . . closed cross-section frame portion
12, 136, 206 . . . closed cross section
14, 227 . . . inner panel
16, 74, 80, 86, 93, 107, 117, 125 . . . foaming adhesive material
21, 31, 102, 112, 141, 151, 202, 203, 204 . . . first and second outer panels (a plurality of outer panels)
38, 62, 104, 182, 246 . . . through hole
43a . . . portion facing foaming adhesive portion
45, 184, 188, 248 . . . gap
51, 75, 81, 87, 94, 108, 118, 126 . . . temporary fixing portion
52, 76, 82, 88, 95 . . . insertion portion
53 . . . fitting portion
55, 119, 127 . . . foaming adhesive portion
55b . . . surface of foaming adhesive portion, which opposes lower joint piece (surface opposing the other of closed cross-section frame portion and inner panel)
72 . . . guide hole
52b, 76a, 82a, 88a, 95a . . . distal end portion of insertion portion
52a, 76b, 82b, 88b . . . proximal portion of insertion portion
77, 83 . . . groove
89, 96 . . . slit
105 . . . locking piece
115 . . . engaging hole
135a . . . inner surface of closed cross-section frame portion
161-164 . . . first to fourth inner panels (inner panels)
171 . . . shielding wall
171a . . . outer edge of shielding wall
172-177, 186 . . . first to sixth joint pieces (joint pieces)
181, 187, 245 . . . recess
203 . . . second interior-side outer panel (second outer panel)
204 . . . second trunk-side outer panel (second outer panel)
212, 215 . . . second upper and lower interior dividing potions (dividing portions)
217 . . . interior overlapping portions (overlapping portions)
227 . . . second upper trunk dividing portion (dividing portion, inner panel)
232 . . . second lower trunk dividing portion (dividing portion)
234 . . . trunk overlapping portions (overlapping portions)

1. A vehicle body framework structure in which a closed cross-section frame portion having a closed cross section is formed by welding a plurality of outer panels, and an inner panel arranged in the closed cross section is formed in the closed cross-section frame portion, wherein
the inner panel includes:
a shielding wall perpendicular to a longitudinal direction of the closed cross-section frame portion, and having an outer edge formed along an inner surface of the closed cross-section frame portion; and
a joint piece projected along the inner surface of the closed cross-section frame portion from the outer edge of the shielding wall,
a gap is set between the joint piece and the closed cross-section frame portion by forming a recess in one of the joint piece and the closed cross-section frame portion such that the recess is recessed away from the other, and
a foaming adhesive material is placed in the gap, and adheres the inner panel and the closed cross-section frame portion by foaming.

2. The vehicle body framework structure according to claim 1, wherein the foaming adhesive material includes:
a temporary fixing portion to be temporarily fixed to one of the closed cross-section frame portion and the inner panel; and
a foaming adhesive portion formed in the temporary fixing portion, and configured to adhere the inner panel and the closed cross-section frame portion.

3. The vehicle body framework structure according to claim 2, further comprising a guide hole in a portion, which faces the foaming adhesive portion, of the other of the closed cross-section frame portion and the inner panel.

4. The vehicle body framework structure according to claim 2, wherein the temporary fixing portion and the foaming adhesive portion of the foaming adhesive material are integrated by a foaming adhesive capable of adhering the inner panel and the closed cross-section frame portion.

5. The vehicle body framework structure according to claim 4, wherein the foaming adhesive is a molded composition which, when foaming by heating, adheres to the inner panel and the closed cross-section frame portion, and increases rigidity.

6. The vehicle body framework structure according to claim 2, further comprising a through hole which is formed in one of the closed cross-section frame portion and the inner panel, and into which the temporary fixing portion is inserted, wherein
the temporary fixing portion includes:
an insertion portion configured to reduce a diameter toward a distal end portion such that the insertion portion can be inserted into the through hole; and
a fitting portion formed in a proximal portion of the insertion portion, and formed into a recessed shape such that the fitting portion can be fitted in the through hole, and
the temporary fixing portion is temporarily fixed to one of the closed cross-section frame portion and the inner panel by fitting the fitting portion in the through hole.

7. The vehicle body framework structure according to claim 6, wherein the temporary fixing portion includes at least one groove configured to open in a distal end portion of the insertion portion, and extend toward the proximal portion of the insertion portion.

8. The vehicle body framework structure according to claim 6, wherein the temporary fixing portion includes at least one slit configured to extend in an axial direction of the foaming adhesive material, and open in a direction perpendicular to the axial direction of the foaming adhesive material.

9. The vehicle body framework structure according to claim 8, wherein the slit is extended to the foaming adhesive portion such that a surface of the foaming adhesive material, which opposes the other of the closed cross-section frame portion and the inner panel, opens.

10. The vehicle body framework structure according to claim 6, wherein one of the closed cross-section frame portion and the inner panel includes a locking piece configured to deform while abutting against the temporary fixing portion to be inserted into the through hole.

11. The vehicle body framework structure according to claim 4, wherein
the temporary fixing portion and the foaming adhesive portion of the foaming adhesive material are formed into a substantially U shape when viewed sideways such that one of the closed cross-section frame portion and the inner panel is sandwiched,
the foaming adhesive material includes a pawl formed on one of the temporary fixing portion and the foaming adhesive portion, and
the pawl engages with an engaging hole formed in one of the closed cross-section frame portion and the inner panel, in a state in which the foaming adhesive material sandwiches one of the closed cross-section frame portion and the inner panel.

12. (canceled)

13. A vehicle body framework structure in which a closed cross-section frame portion having a closed cross section is formed by welding a plurality of outer panels, wherein
the plurality of outer panels include a first outer panel and at least two second outer panels,
the closed cross-section frame portion as a vehicle body framework is formed by assembling the at least two second outer panels to the first outer panel,
the at least two second outer panels are divided in a longitudinal direction of the closed cross-section frame portion, thereby forming a dividing portion in each second outer panel,
overlapping portions are formed by overlapping the dividing portions such that one of the overlapped dividing portions is arranged outside the closed cross section, and the other dividing portion is arranged inside the closed cross section,
a gap is set between the overlapping portions, and
a foaming adhesive material is placed in the gap, and adheres the overlapping portions by foaming.
